(19) United States
(12) Patent Application Publication
(10) Pub. No.: US 2016/0078509 A1
(43) Pub. Date: Mar. 17, 2016

(54) APPARATUS, SYSTEM, AND METHOD OF MANAGING TRANSACTIONS OF ELECTRONIC BOOKS

(71) Applicant: Kenta YAMANO, Kanagawa (JP)

(72) Inventor: Kenta YAMANO, Kanagawa (JP)

(21) Appl. No.: 14/856,994

(22) Filed: Sep. 17, 2015

(30) Foreign Application Priority Data
Sep. 17, 2014 (JP) 2014-188415
Sep. 17, 2014 (JP) 2014-188420

(51) Int. Cl. G06Q 30/06; G06Q 30/02

(52) U.S. Cl. CPC G06Q 30/0609; G06Q 30/0283

(57) ABSTRACT

A server at an e-book sales agency generates and transmits an order of purchasing an e-book to a server at an e-book store on behalf of the user using authentication information of the user for the e-book store, and updates charge fee information to be used for calculating an amount of fee that is charged to the e-book store by the e-book sales agency.

### CROSS-REFERENCE TO RELATED APPLICATIONS

This patent application is based on and claims priority pursuant to 35 U.S.C. §119(a) to Japanese Patent Application Nos. 2014-188415, filed on Sep. 17, 2014, and 2014-188420, filed on Sep. 17, 2014, in the Japan Patent Office, the entire disclosure of which is hereby incorporated by reference herein.

### BACKGROUND

1. Technical Field

The present invention generally relates to managing transactions of electronic books.

2. Description of the Related Art

While books in digital format, called electronic books (e-books), are largely available, not many people prefer buying e-books. For example, some people tend to believe that reading paper books would be more comfortable than reading e-books, without really trying to read e-books, such that they keep buying paper books. In another example, some people actually feel more comfortable with reading paper books, such that they keep buying paper books. However, even such people may want to sometimes have e-books especially when they are travelling.

### SUMMARY

Example embodiments of the present invention include a server at an e-book sales agency generates and transmits an order of purchasing an e-book to a server at an e-book store on behalf of the user using authentication information of the user for the e-book store, and updates charge fee information to be used for calculating an amount of fee that is charged to the e-book store by the e-book sales agency.

Example embodiments of the present invention include a system of managing transactions of e-books, including a first server at an e-book sales agency and a second server at an e-book store. The system generates an order of purchasing an e-book at the e-book store, on behalf of the user using authentication information of the user for the e-book store. The system further updates charge fee information to be used for calculating an amount of fee that is charged to the e-book store by the e-book sales agency.

Example embodiments of the present invention include a method of managing transactions of e-books, and a non-transitory recording medium storing a program for the system to manage transactions of e-books.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a network system including an e-book sales agency system (server) according to an embodiment of the present invention;

FIG. 2A is a schematic block diagram illustrating a hardware configuration of a server of the network system of FIG. 1;

FIG. 2B is a schematic block diagram illustrating a hardware configuration of a user terminal of the network system of FIG. 1;

FIG. 3 is a schematic block diagram illustrating a functional configuration of the e-book sales agency server of the network system of FIG. 1;

FIGS. 4A to 4C (FIG. 4) are an illustration of example user registration screens;

FIG. 5 is an illustration of an example data structure of a user information registration table;

FIGS. 6A and 6B (FIG. 6) are a data sequence diagram illustrating operation of processing an order of purchasing an e-book associated with a paper book, performed by the e-book sales agency of FIG. 1, according to an embodiment of the present invention;

FIG. 7A is an illustration of an example login screen;

FIG. 7B is an illustration of an example input selection screen;

FIG. 7C is an illustration of an example code input screen;

FIG. 7D is an illustration of an example code input screen;

FIG. 8 is an illustration of a paper book printed with ISBN;

FIG. 9A is an illustration of an example e-book store selection screen;

FIG. 9B is an illustration of an example order confirmation screen;

FIG. 10 is an illustration of an example charge fee management table;

FIG. 11 is a schematic block diagram illustrating a network system including an e-book sales agency system (server), according to an embodiment of the present invention;

FIG. 12 is a schematic block diagram illustrating a functional configuration of the e-book sales agency server of FIG. 11;

FIG. 13 is a data sequence diagram illustrating operation of assigning a book ID to each book to be printed, performed by the e-book sales agency server of FIG. 11, according to an embodiment of the present invention;

FIG. 14 is an example data structure of a book information management table;

FIG. 15 is an illustration of a paper book printed with a book ID;

FIG. 16 is a data sequence diagram illustrating operation of managing an activation flag of the paper book, performed by the e-book sales agency server of FIG. 11, according to an embodiment of the present invention;

FIGS. 17A and 17B (FIG. 17) are a data sequence diagram illustrating operation of processing an order of purchasing an e-book associated with a paper book, performed by the e-book sales agency of FIG. 11, according to an embodiment of the present invention;

FIG. 18A is an illustration of an example login screen;

FIG. 18B is an illustration of an example service menu screen;

FIG. 18C is an illustration of an example two-dimensional code screen;

FIG. 19A is an illustration of an example screen having a message;

FIG. 19B is an illustration of an example screen having a message;

FIG. 20A is an illustration of an example e-book store selection screen;

FIG. 20B is an illustration of an example order confirmation screen;

FIG. 21 is a data sequence diagram illustrating operation of managing an activation flag of the used paper book, performed by the e-book sales agency server of FIG. 11, according to an embodiment of the present invention;

FIGS. 22A and 22B (FIG. 22) are a data sequence diagram illustrating operation of collecting a paper book in response to a request for exchanging the paper book with an e-book associated with the paper book, performed by the e-book sales agency of FIG. 11, according to an embodiment of the present invention;

FIG. 23 is a data sequence diagram illustrating operation of processing an order of purchasing an e-book associated with a paper book, performed by the e-book sales agency of FIG. 11, according to an embodiment of the present invention;

FIGS. 24A and 24B (FIG. 24) are an example data structure of a book collection status management table;

FIG. 25 is an illustration of an example exchange reservation screen;

FIGS. 26A and 26B are an illustration of an example e-book store selection screen;

FIG. 26C is an illustration of an example order confirmation screen;

FIG. 27 is a schematic block diagram illustrating a network system including an e-book sales agency system (server), according to an embodiment of the present invention;

FIG. 28 is an illustration for explaining a service of exchanging a paper book with an e-book, provided by the e-book sales agency of FIG. 27;

FIG. 29 is a schematic block diagram illustrating a hardware configuration of a used book seller server of the network system of FIG. 27, when implemented by a mobile personal computer;

FIG. 30 is a schematic block diagram illustrating a functional configuration of the e-book sales agency server of FIG. 27;

FIG. 31 is a data sequence diagram illustrating operation of processing a request for exchanging a paper book with an e-book to issue an electronic coupon, performed by the e-book sales agency server of FIG. 27, according to an embodiment of the present invention;

FIG. 32A is an illustration of an example e-book coupon issuance screen;

FIG. 32B is an illustration of an example QR code screen with an access to a coupon download page;

FIG. 32C is an illustration of an example error screen;

FIG. 33 is an illustration of an example data structure of a book information management table;

FIG. 34A is an illustration of an example coupon download page;

FIG. 34B is an illustration of an example link page having a link to an e-book sales page;

FIG. 35 is a data sequence diagram illustrating operation of processing an order of purchasing an e-book using the electronic coupon, performed by the e-book sales agency server of FIG. 27, according to an embodiment of the present invention;

FIG. 36A is an illustration of an example sales page of the e-book;

FIG. 36B is an illustration of an example order confirmation screen;

FIG. 37 is an illustration of an example data structure of a sales management table;

FIG. 38 is an illustration of an example data structure of a book information management table;

FIG. 39 is an illustration of an example e-book selection screen; and

FIG. 40 is an illustration of an example data structure of a sales management table.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As described below referring to some embodiments, an e-book sales agency offers a business platform through connecting an e-book store with a user to promote sales of e-books while satisfying the need from the user. The e-book store thus benefits from such platform as sales of e-books increase. The e-book sales agency charges a fee for providing such business platform to each e-book store.

For example, the e-book sales agency may have an agreement with the e-book store such that the e-book store offers a digital content version of a paper book (e-book) at a special price to the user who owns that paper book. In this disclosure, a digital content version of a book is referred to as an “e-book”, and the paper book itself is referred to as a “paper book”. In this manner, the user who owns the paper book is encouraged to purchase the e-book. In some cases, the e-book store may offer the e-book at free, to promote distribution of e-books. In other cases, in alternative to selling the digital content of the paper book that the user currently owns, the e-book store may even offer a different title of e-book, to promote distribution of such e-book. More specifically, the user may request the e-book sales agency for any title of e-book, irrespective of whether or not the user owns a paper book for that e-book, to purchase that e-book from the e-book store that the e-book sales agency has an agreement with. As described below, the e-book store that the e-book sales agency has the agreement with may be one or more e-book stores.

In order to implement such business platform, in particular, the e-book sales agency provides a system for simplifying the process of purchasing an e-book for the user. For example, in response to receiving a request for purchasing an e-book from the user at a user terminal, a server at the e-book sales agency identifies the e-book that the user can purchase (for example, with a help from the e-book store), and places an order of purchasing the e-book to a server at the e-book store. The server at the e-book sales agency further redirects the user terminal to a web page provided by the e-book store, such that the user can confirm the order of purchasing the e-book, and purchase the e-book.

With this system, the user at the user terminal can easily purchase the e-book, even without directly accessing the web page provided by the e-book store for authentication, or searching web pages to look for the e-book store that offers the digital content version of the paper book that the user currently owns.

In alternative to allowing the user to have a right to purchase the e-book at a special price, the user may sometimes exchange the paper book with the e-book. In view of this, in another embodiment, the e-book sales agency offers a business platform through connecting the e-book store and a used book store with a user to promote exchange of a paper book with an e-book. The e-book store thus benefits from such platform as sales of e-books increase. The used book store benefits from such platform as collection of used books increase. The e-book sales agency charges a fee for providing such business platform to at least one of e-book store and used book store.

In order to implement such business platform, the e-book sales agency server may further manage collection of the paper book, for example, with a book collection center. Based on confirmation that the paper book is arrived at the book collection center, the e-book sales agency server proceeds to the process of purchasing the e-book on behalf of the user.

With such system, the user at the user terminal can easily purchase the e-book in exchange of the paper book, even without directly accessing the web page provided by the e-book store or the used book store for authentication, or searching web pages to look for the e-book store or the used book store.

### First Embodiment

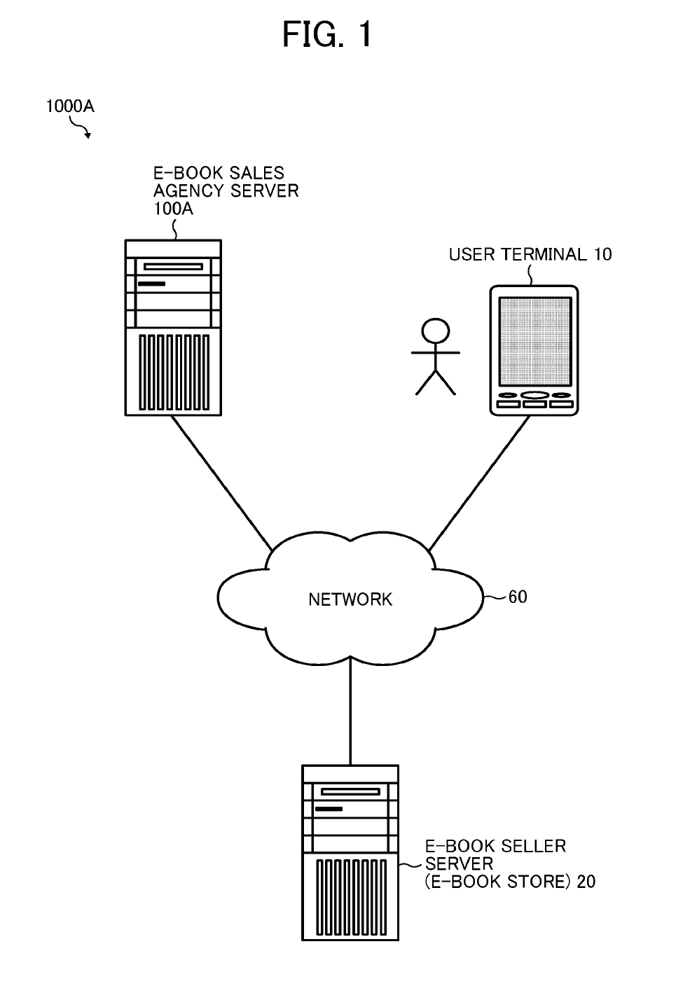

FIG. 1 is a schematic diagram illustrating a configuration of a network system 1000A, which includes an e-book sales agency system (server) 100A and an e-book seller server 20. The e-book seller server 20 is a server of an e-book store on the Internet. Although only one e-book seller server 20 is shown in FIG. 1 for simplicity, it is assumed that a plurality of servers are provided for corresponding e-book stores on the Internet. The e-book sales agency system 100A corresponds to a server of an e-book sales agency. The e-book sales agency system 100A and the e-book seller server 20 are connected through a network 60 such as the Internet or virtual private network (VPN) to be communicable with each other. The e-book sales agency system 100A and the e-book seller server 20 may each be implemented by one computer or a plurality of computers. Further, any one of the servers and the user terminal in the network system 1000A could be located at any place, such as within one country, or over different countries. For simplicity, the e-book sales agency system 100A may be referred to as the e-book sales agency server 100A or the e-book sales agency, and the e-book seller server 20 may be referred to as the e-book store.

In this embodiment, the e-book sales agency offers a business platform through connecting each e-book store with each user to promote sales of e-books while satisfying the need from the customer. The e-book store thus benefits from such platform as sales of e-books increase. The e-book sales agency charges a fee for providing such business platform to each e-book store. As described below, the business platform provided by the network system 1000A is operated and maintained by the e-book sales agency in cooperation with the e-book store.

There may be some cases in which the user who owns the paper book desires to have a digital content version of such paper book. For example, the user may desire to read the paper book at home, but to read the e-book while the user is travelling. If the user who owns the paper book is offered with a discount price (even at free) for purchasing the e-book for that paper book, the user may be encouraged to purchase the e-book.

In view of this, in the following embodiment illustrated in FIGS. 1 to 10, the e-book sales agency provides a service for facilitating a purchase of an e-book of a paper book that the user currently owns. For example, the e-book sales agency offers a right to purchase the e-book of the paper book at a special price (such as a discount price including the “0” price), to the user who owns that paper book.

Further, the e-book sales agency simplifies a process of purchasing the e-book of the paper book, for the user who owns that paper book, for example, through displaying a list of e-book stores that the user can purchase from and further placing an order of purchasing that e-book on behalf of the user. Accordingly, the user is encouraged to purchase the e-book.

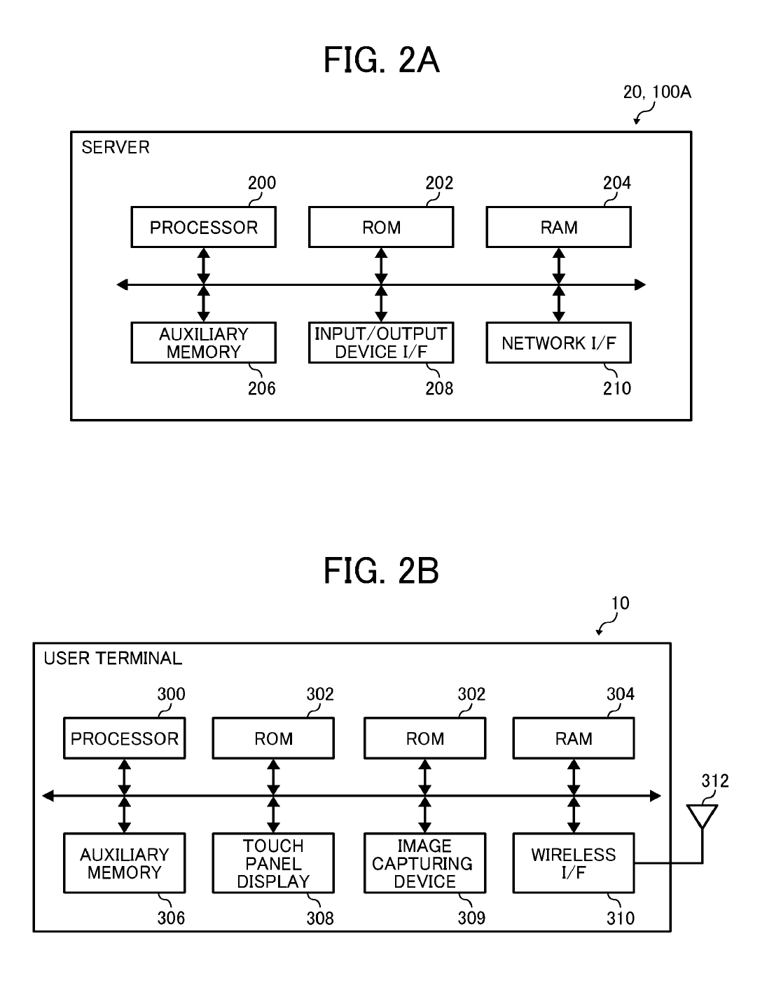

Referring to FIGS. 2A and 2B, a hardware configuration of the network system 1000A is explained according to an example embodiment of the present invention.

FIG. 2A illustrates a hardware configuration of each one of the sales agency system 100A and the e-book seller server 20, which may be implemented by one or more computers operating as a “server”. Referring to FIG. 2A, the server includes a processor 200, a read only memory (ROM) 202, a random access memory (RAM) 204, an auxiliary memory 206, an input/output interface (I/F) 208, and a network I/F 210, which are connected through a bus.

The processor 200 controls an entire operation of the server. The ROM 202 is a non-volatile memory that stores various programs such as a boot program like BIOS, and firmware. The RAM 204 is a non-volatile memory that functions as a work memory for the processor 200 in executing the program. The auxiliary memory 206 may be implemented by a hard disk drive (HDD) of large-size capacity, which stores an operating system and application. The input/output I/F 208 is an interface that connects the server with an input device such as a mouse, keyboard, or touch panel, or an output device such as a display. The network I/F 210 is an interface that connects the server with the network 60. The server of FIG. 2A operates under control of the OS to perform various operations according to the program.

FIG. 2B illustrates a hardware configuration of the user terminal 10, which may be implemented by a personal computer (PC). The user terminal 10 is preferably a mobile device such as a notebook PC, a tablet PC, a personal digital assistance (PDA), which is capable of communicating wirelessly. In this embodiment, the user terminal 10 is implemented by a smart phone such that the user terminal 10 may be referred to as the smart phone 10. Referring to FIG. 2B, the smart phone 10 includes a processor 30, a ROM 302, a RAM 204, an auxiliary memory 306, a touch panel display 308, an image capturing device 309, and a wireless I/F 310.

The processor 300 controls entire operation of the user terminal 10. The ROM 302 is a non-volatile memory that stores various programs such as a boot program like BIOS, and firmware. The RAM 304 is a non-volatile memory that functions as a work memory for the processor 300 in executing the program. The auxiliary memory 306 may be implemented by a hard disk drive (HDD) of large-size capacity, which stores an operating system and application. The touch panel display 308 (“display 308”) is a display capable of displaying various information to the user, and receiving various user inputs through a touch panel. The image capturing device 309, which may be implemented by a camera, captures an image. The wireless I/F 310 inputs or outputs wireless signals to the outside device through an antenna 312.

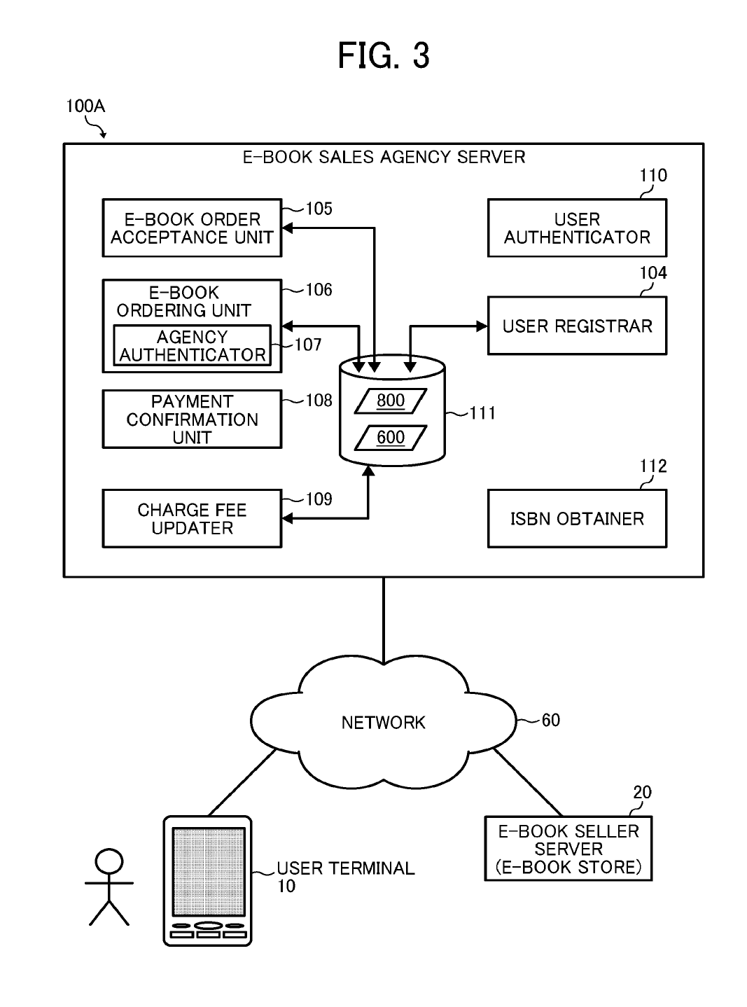

Referring to FIG. 3, a functional configuration of the e-book sales agency server 100A is explained according to the embodiment of the present invention.

As illustrated in FIG. 3, the e-book sales agency server 100A includes an ISBN obtainer 112, a user registrar 104, an e-book order acceptance unit 105, an e-book ordering unit 106, a payment confirmation unit 108, a charge fee updater 109, a user authenticator 110, and a database 111.

The ISBN obtainer 112 obtains an International Standard Book Number (ISBN) of a paper book, which is identification of the paper book, from the user terminal 10 operated by a user who requests purchase of an e-book.

The user registrar 104 centrally manages information regarding the user who has registered, such as account information of the user for each e-book store, for example, by storing information regarding the registered user to the database 111.

The e-book order acceptance unit 105 accepts, from the user at the user terminal 10, a purchase order of an e-book that is associated with the paper book owned by the user.

The e-book ordering unit 106 sends the e-book purchase order to the e-book seller server 20 on behalf of the user at the user terminal 10. The e-book ordering unit 106 includes an agency authenticator 107, which logs in the e-book seller server 20 on behalf of the user using account information of the user who has registered through the user registrar 104.

The payment confirmation unit 108 obtains information regarding payment of the e-book that is ordered, from the e-book seller server 20.

The charge fee updater 109 updates information regarding a charge fee, based on the payment information obtained from the e-book seller server 20.

The user authenticator 110 authenticates the user at the user terminal 10, who uses services provided by the e-book sales agency.

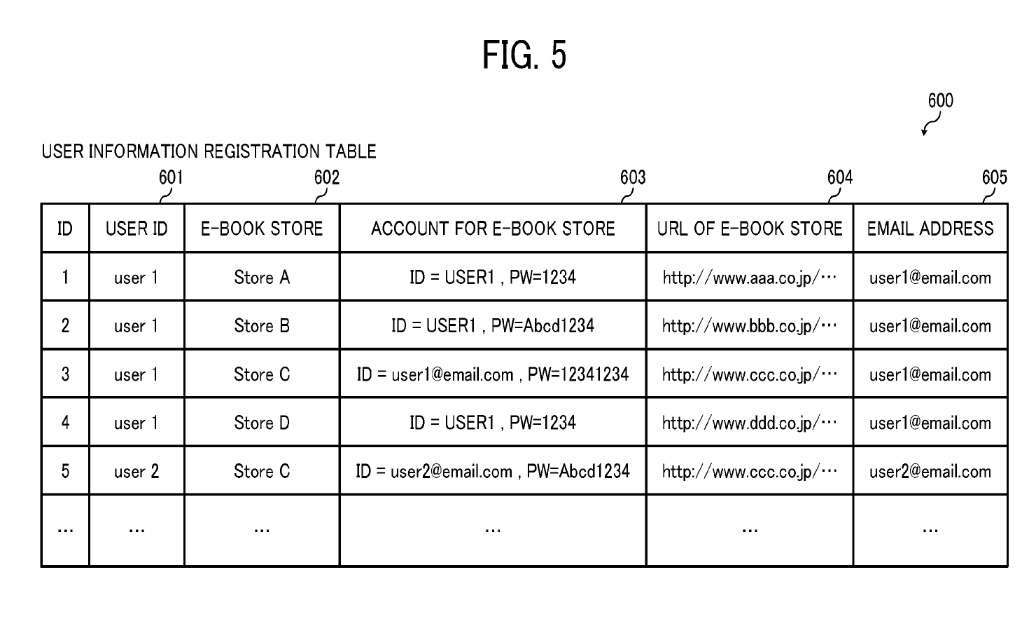

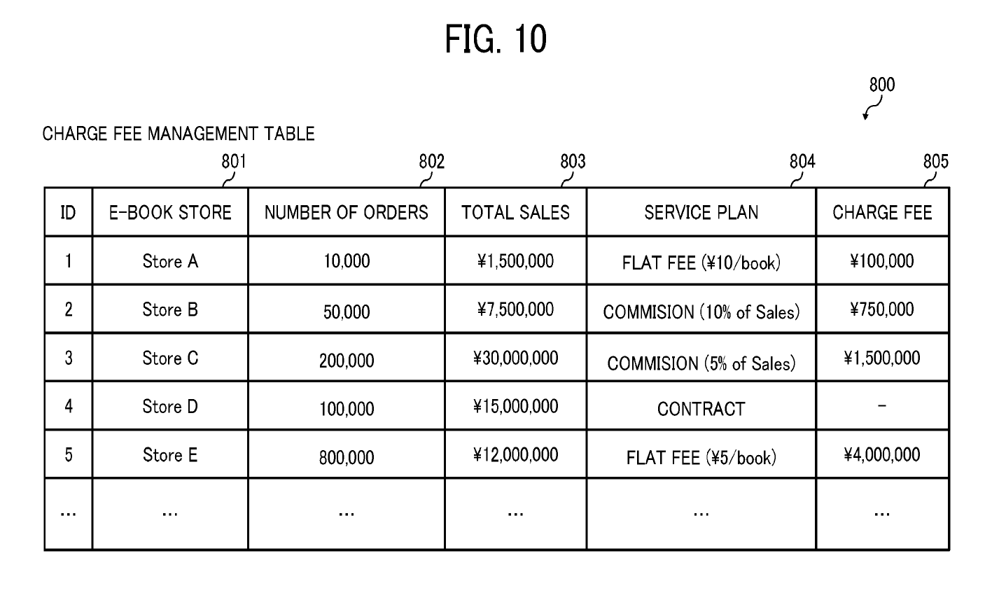

The database 111 stores various information to be used by the e-sales agency server 100A, such as a user information registration table 600 (FIG. 5) and a charge fee management table 800 (FIG. 10).

The above-described units in FIG. 3 are implemented by a plurality of instructions that are generated by the processor 200 according to a program stored on any desired memory such as the RAM 204. The database 111 is implemented by the processor 200 in cooperation with any desired memory such as the ROM 202 or the auxiliary memory 206.

Now, operation of registering a user at the e-book sales agency server 100A and e-book stores to be used by that user is explained according to an embodiment of the present invention.

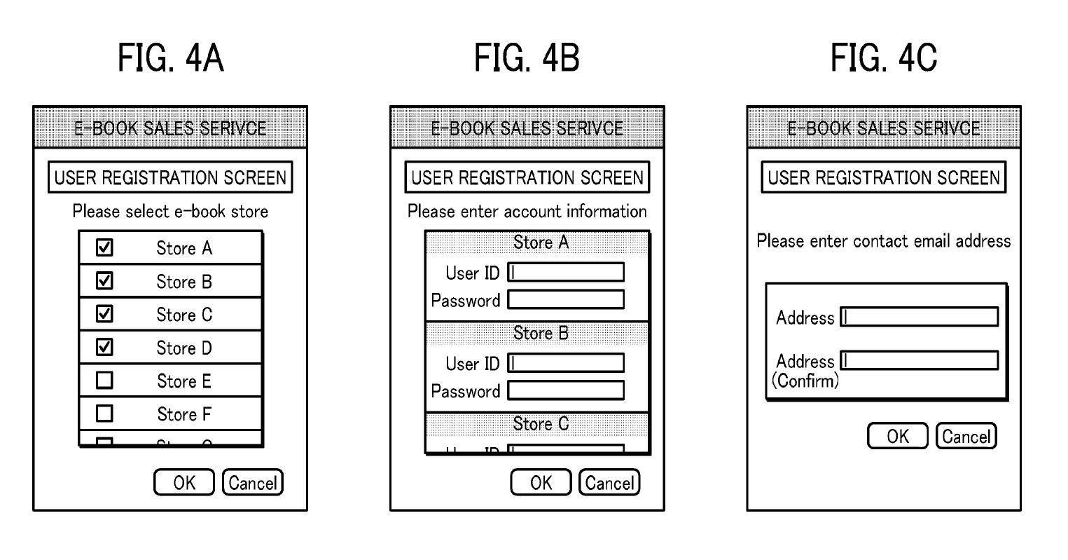

In response to a request for registering, the user registrar 104 of the e-book sales agency server 100A sends a user registration screen for display at the user terminal 10. The user terminal 10 displays the user registration screen through the touch panel display 308. FIG. 4A to 4C (FIG. 4) illustrate screens to be displayed to the user in registration. The screen of FIG. 4A is firstly displayed, which lists a plurality of e-book stores for selection by the user. These e-book stores to be displayed on the user registration screen are those stores, which have been previously registered as users of e-book sales agency service provided by the e-book sales agency. The user at the user terminal 10 selects one or more e-book stores from the list of e-book stores shown on the screen of FIG. 4A, such as the e-book stores that the user already has a user account.

In response to selection of e-book store by the user, the user registration screen of FIG. 4A is switched to a user registration screen of FIG. 4B, which requests the user to input account information. The user at the user terminal 10 inputs account information of each store that the user has selected, such as the user ID and the password, and presses the “OK” key. The account information in this example is used to authenticate the user in accessing a web page provided by the corresponding one of the e-book stores. The user registration screen of FIG. 4B is switched to a user registration screen of FIG. 4C, which requests the user to input contact information of the user such as an email address of the user.

As information regarding selection of e-store and input of user-related information (such as user account information) is received from the user terminal 10, the user registrar 104 of the e-book sales agency server 100A registers such information to the user information registration table 600 of FIG. 5. As illustrated in FIG. 5, the user information registration table 600 includes a “user ID” field 601 for storing a user ID of the user, an “e-book store” field 602 for storing identification (such as a name) of an e-book store, an “e-book account” field 603 for storing account information (such as the user ID and password) of the user for the e-book store, an “URL of e-book store” field 604 for storing the URL of the e-book store, and an “email address” field 605 for storing the email address of the user, for each of the selected e-book stores for each user. In this example, the user ID is previously assigned to the user by the e-book sales agency. The user information registration table of FIG. 5 indicates that the user with the user ID “user 1” has selected the e-book stores A, B, C, and D, as an e-book store that the user may purchase an e-book from.

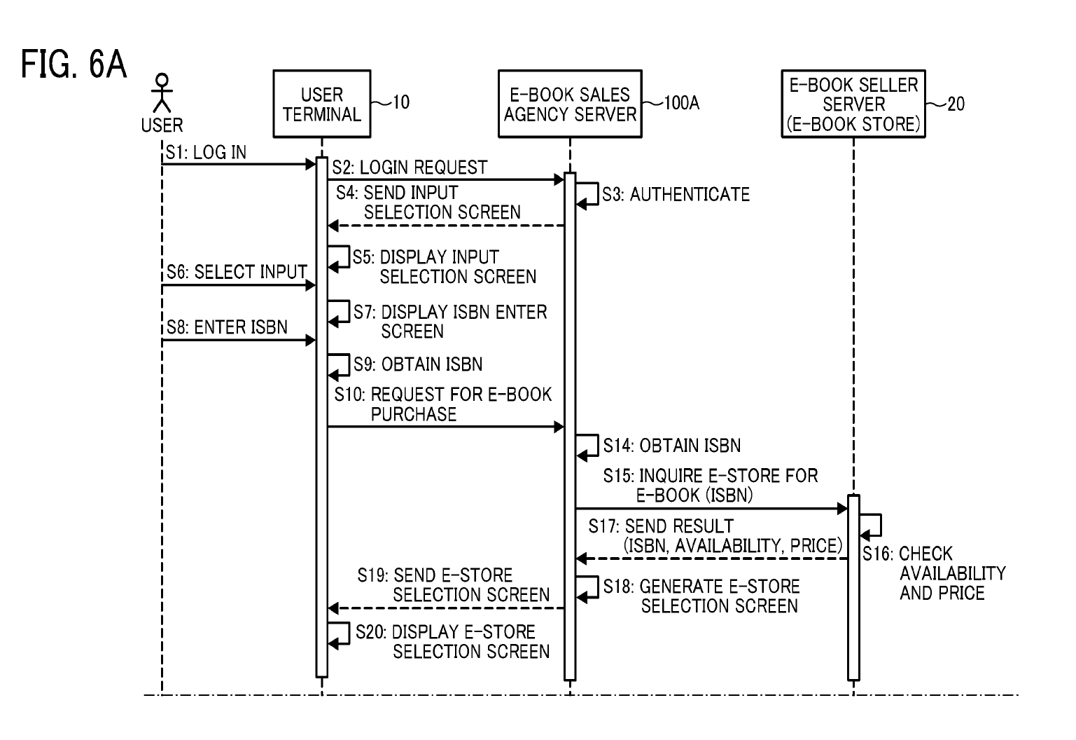

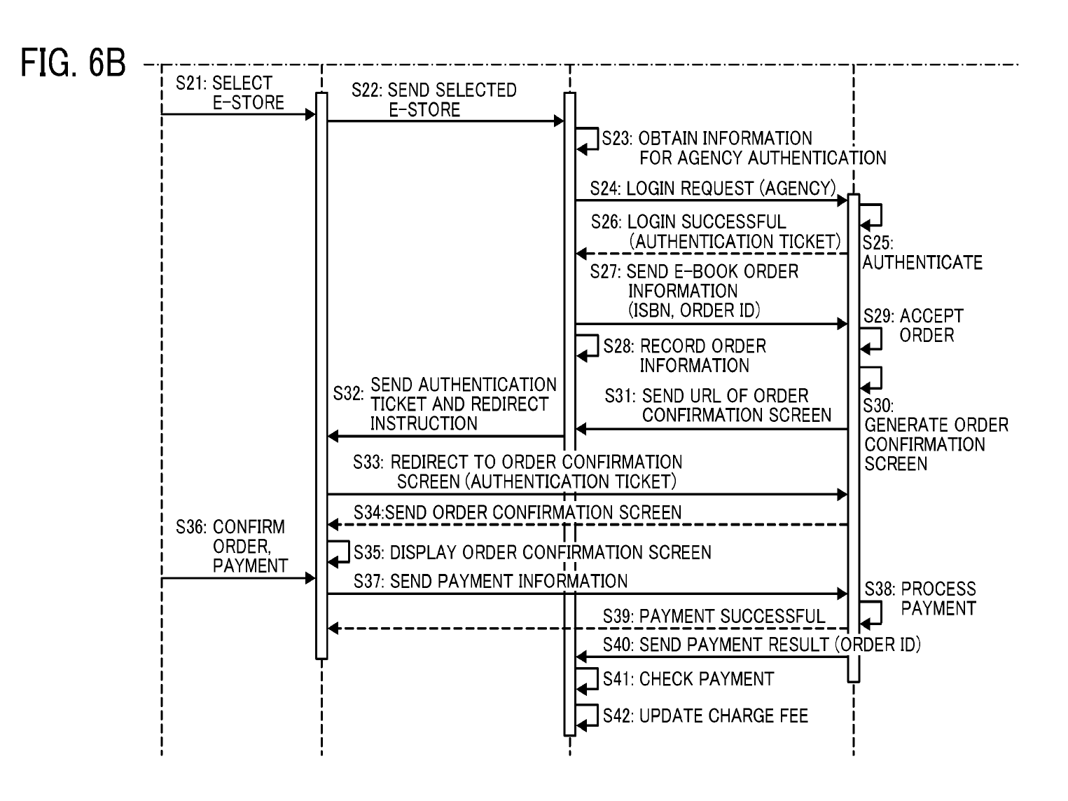

Referring to FIG. 6, operation of processing an order of purchasing an e-book associated with a paper book, is explained according to an embodiment of the present invention. In this embodiment, it is assumed that the user requests to purchase a digital content version (“e-book”) of a paper book that the user previously bought at a book store.

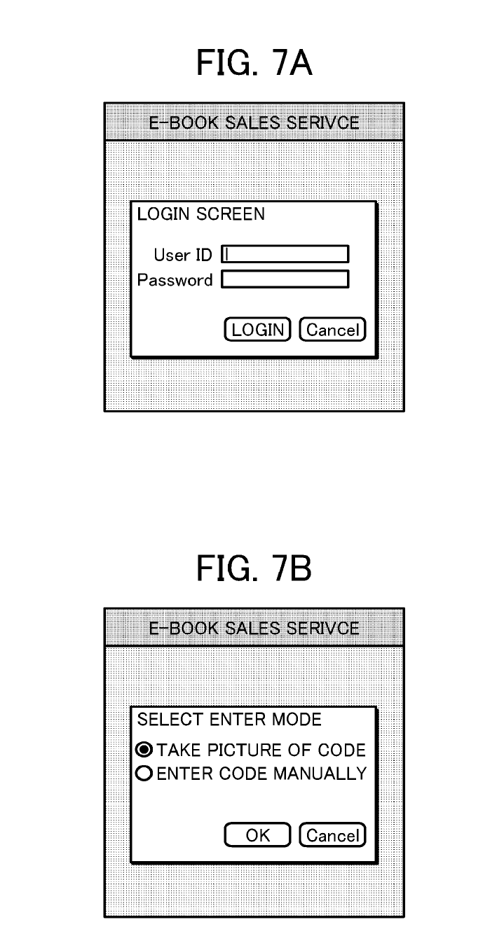

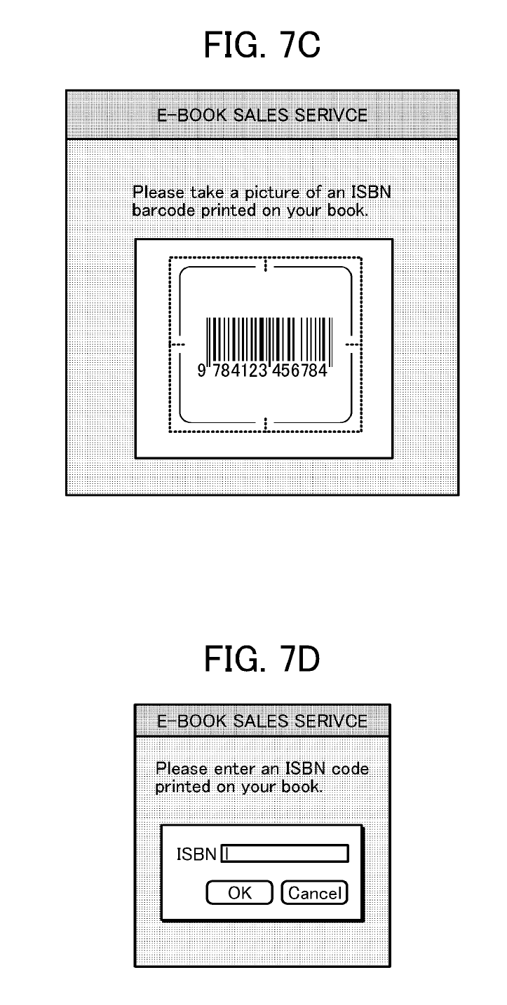

At S1, the user terminal 10 receives a login request from the user, which requests to log in the e-book sales agency server 100A. FIG. 7A is an example login screen displayed at the display 308 of the user terminal 10.

As the user at the user terminal 10 inputs the user ID and the password through the login screen of FIG. 7A and presses the “log in” key using the touch panel display 308, at S2, the wireless I/F 310 of the user terminal 10 transmits a login request including the user ID and password that are input to the e-book sales agency server 100A through the network 60.

At S3, the user authenticator 110 of the e-book sales agency server 100A authenticates the user using the user ID and password of the received login request. More specifically, the user authenticator 110 determines whether a set of user ID and password of the login request is stored in the memory of the e-book sales agency server 100A, such as in the user information registration table (FIG. 5). When the set of user ID and password of the login request is stored, the user authenticator 110 determines that the user is an authenticated user. When authentication is successful, at S4, the e-book order acceptance unit 105 transmits an input selection screen to the user terminal 10, which requests the user to select a method of entering identification of the paper book such as the ISBN of the paper book.

At S5, the processor 300 of the user terminal 10 controls the display 308 to display the input selection screen, which is received from the e-book sales agency server 100A, to the user. FIG. 7B is an example input selection screen, which requests the user to select a method of entering the ISBN of the paper book, from the option “take a picture of code” and the option “enter code manually”.

As the user selects one of the options and selects the “OK” key using the touch panel display 308, at S6, the user terminal 10 receives information regarding the selected input method. At S7, the display 308 of the user terminal 10 displays a code input screen of FIG. 7C or 7D according to the selected input method. More specifically, when the option “take a picture of code” is selected, the display 308 of the user terminal 10 displays the code input screen of FIG. 7C that requests the user to read a ISBN barcode printed on the paper book using the camera (image capturing device 309) provided with the smart phone 10. When the “enter code manually” is selected, the display 308 of the user terminal 10 displays the code input screen of FIG. 7D that requests the user to manually enter the ISBN of the paper book into a text box on the screen.

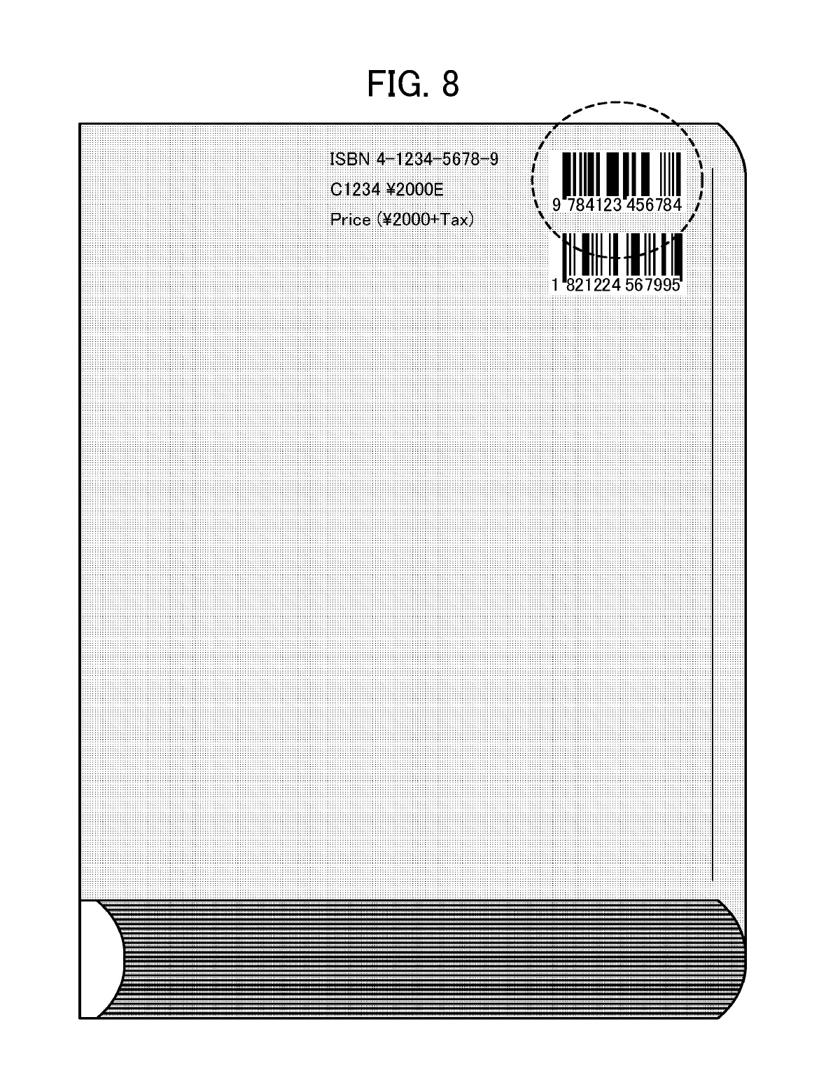

As the code input screen of FIG. 7C or 7D is displayed on the display 308, the user enters the ISBN of the paper book that the user currently owns (for example, through purchasing at the book store), with the selected input method. More specifically, when the user selects “take a picture of code”, the user instructs the terminal 10 to read the barcode of the ISBN printed on the paper book as illustrated in FIG. 8. When the user selects “enter code manually”, the user manually inputs, into the text book of the form being displayed, a string of numbers “9784123 . . . ” that is printed below the barcode of the ISBN on the paper book. The user terminal 10 receives the user input on the ISBN at S8, and obtains the ISBN of the paper book at S9. More specifically, at S9, when the “take a picture of code” is selected, the processor 300 of the user terminal 10 decodes the barcode of the ISBN, which is captured by the camera, to obtain the ISBN of the paper book. When the “take a picture of code” is selected, the processor 300 of the user terminal 10 obtains the input numeral string as the ISBN of the paper book.

At S10, the processor 300 of the user terminal 10 generates a request for purchasing the e-book associated with the paper book having the obtained ISBN, and transmits the e-book purchase request to the e-book sales agency server 100A through the wireless I/F 310. The e-book purchase request includes the ISBN obtained at the user terminal 10.

When the e-book sales agency server 100A receives the e-book purchase request, the e-book order acceptance unit 105 obtains the ISBN of the paper book, included in the e-book purchase request.

The above-described S9, S10, and S14 may be performed in various other ways. For example, in alternative to obtaining the ISBN of the paper book from the image of the barcode that is captured at the terminal 10, the e-book sales agency server 100A may decode the barcode of the ISBN of the paper book into the ISBN of the paper book. In such case, the user terminal 10 generates the e-book purchase request including the captured barcode image, and sends such request to the e-book sales agency server 100A. The e-book sales agency server 100A analyzes the captured barcode image of the request to obtain the ISBN of the paper book.

At S15, the e-book order acceptance unit 15 generates a request that inquires for the e-book associated with the paper book having the obtained ISBN, and transmits such e-book request to the servers 20 of one or more e-book stores that the user at the user terminal 10 has previously registered. The e-book request inquires the e-book store for information regarding the e-book associated with the paper book that the user currently owns, such as whether the e-book for that paper book is available for sales and a price of that e-book if available. The e-book order acceptance unit 105 refers to the user information registration table 600 of FIG. 5 to obtain information regarding the e-book stores registered for the login user, and sends such e-book request to each e-book store.

For example, in case the user ID of the login user is “user1”, the e-book order acceptance unit 105 searches the user information registration table 600 using the “user1” as a search key to identify the e-book stores A, B, C, and D, and sends the e-book request to the server 20 of each one of the e-book stores A, B, C, and D using the URL of the e-book store.

At S16, the e-book seller server 20 of each e-book store that receives the e-book request searches for an ISBN assigned to the e-book of the paper book, using the ISBN of the paper book that is included in the e-book request. Even for the same book, the ISBN for the e-book and the ISBN for the paper book are different in number. For this reason, the e-book seller server 20 stores association information that associates the ISBN for the e-book and the ISBN for the paper book, for each title of book. Using the ISBN of the e-book associated with the paper book, the processor 200 of the e-book seller server 20 searches availability of the e-book with the obtained ISBN of the e-book, and a sales price of the e-book. At S17, the network I/F 210 of the e-book seller server 20 sends the search result including the ISBN, availability, and price of the e-book that is associated with the paper book that the user currently owns, to the e-book sales agency server 100A.

As the search result including the ISBN, availability, and price of the e-book is received from the e-book seller server 20 of each one of the e-book stores, at S18, the e-book order acceptance unit 15 generates an e-book store selection screen based on the received information.

At S19, the e-book order acceptance unit 105 transmits the e-book store selection screen to the user terminal 10.

At S20, the user terminal 10 causes the display 308 to display the e-book store selection screen.

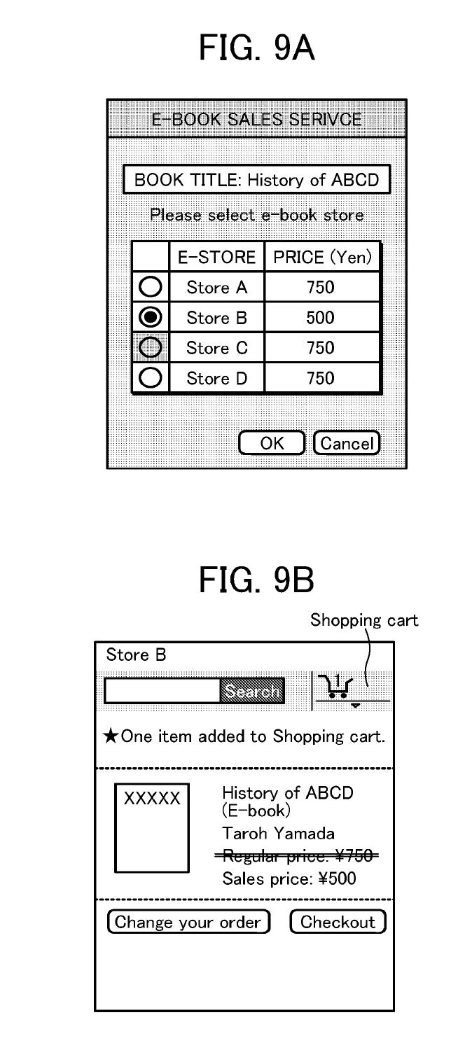

FIG. 9A is an example e-book store selection screen, which lists four e-book stores A, B, C, and D with a sales price of the e-book associated with the paper book that the user currently owns. With this screen, the user at the user terminal 10 is able to select one of the e-book stores that the user wants to purchase the e-book from, for example, based on the price of the e-book. In FIG. 9A, the radio button for the e-book store “C” is grayed to indicate that it cannot be selected, as the search result indicates that e-book is not available for sales.

When the user selects the e-book store “B” that offers the e-book for the lowest price, and selects the “OK” key, at S21, the user terminal 10 receives the user selection of the e-book store. At S22, the user terminal 10 sends the selected e-book store “B” to the e-book sales agency server 100A through the wireless I/F 310.

At S23, the e-book ordering unit 106 searches the user information registration table 600 (FIG. 5) using the user ID of the user at the user terminal 10 and the selected e-book store “B” as a search key, to obtain information that is needed for the e-book ordering unit 106 to order the e-book on behalf of the user. More specifically, the e-book ordering unit 106 searches the user information registration table 600 using the user ID “user1” and the e-book store “B” as a search key to obtain the account information, that is, the user ID “user1” and the password “Abcd1234”, of the user for the e-book store “B” and the URL of the e-book store “B” http://www.bbb.co.jp/ . . . .

At S24, the agency authenticator 107 transmits a login request including the obtained account information (user ID “USER1” and password “Abcd1234”) to the server 20 of the e-book store “B” specified by the URL of the e-book store “B”. In this example, the account information is used for authentication of the user in accessing a web page of the e-book store “B”.

At S25, the processor 200 of the e-book sales server 20 of the e-book store “B” (simply referred to as the e-book store “B” server 20) authenticates the user using the account information of the login request. At S26, the network I/F 210 of the e-book store “B” server sends an authentication result to the agency authenticator 107 of the e-book sales agency server 100A. More specifically, the e-book store “B” server 20 stores, for each one of a plurality of registered users, a set of user ID and password. When the received set of user ID and password matches any one of the stored sets, it is determined that authentication of the user is successful. In this example, it is assumed that the authentication is successful. In such case, the e-book store “B” server 20 generates and sends an authentication ticket to the e-book sales agency server 100A.

At S27, the e-book ordering unit 106 issues an order identification (ID) that identifies an order, generates order information including the issued order ID and the ISBN of the e-book (In this example, the title “History of ABCD”), and transmits the order information to the e-book store “B” server 20. At S28, the agency authenticator 107 stores the order information in association with information regarding the e-book store “B” and the date/time at which the order information is transmitted.

At S29, the processor 200 of the e-book store “B” server 20 accepts and processes the order of purchasing the e-book having the ISBN that is included in the order information received from the e-book sales agency server 100A. More specifically, the e-book store “B” server 20 accepts an order of purchasing the e-book (with the title “History of ABCD” and a regular price of 750 Yen) at the sales price of 500 Yen. In this example, processing the order corresponds to an action of placing a specific item (that is, the e-book) in a shopping cart of the user at the user terminal 10.

At S30, the processor 200 of the e-book store “B” server 20 generates an order confirmation screen. At S31, the e-book store “B” server 20 transmits the URL of the order confirmation screen to the e-book sales relay server 100A through the network I/F 210.

At S32, the e-book ordering unit 106 generates a redirect request that requests the user terminal 10 to redirect to the URL of the order confirmation screen, and transmits the redirect request with the authentication ticket received at S26 to the user terminal 10.

At S33, the user terminal 10, which receives the redirect request, redirects, that is, accesses the URL of the order confirmation screen with the authentication ticket. More specifically, using the authentication ticket, a session is established between the user terminal 10 and the e-book store “B” server 20. At S34, the e-book store “B” server 20 transmits the order confirmation screen to the user terminal 10. At S35, the user terminal 10 causes the display 308 to display the order confirmation screen of the e-book store “B”.

FIG. 9B illustrates an example order confirmation screen for display at the user terminal 10. The order confirmation screen of FIG. 9B displays an image reflecting the e-book “History of ABCD”, and the price “500 Yen”.

As the user at the user terminal 10 selects the “Check out” key, the user terminal 10 displays a payment screen provided by the e-book store “B” that requests the user to input such as information regarding a credit card. After inputting such information to process payment, at S36, the user terminal 10 receives payment information from the user. At S37, the user terminal 10 sends the payment information to the e-book store “B” through the wireless I/F 310.

The e-book store “B” server 20 processes payment using the payment information received from the user terminal 10 at S38, and transmits a payment (settlement) result including the order ID to the user terminal 10 at S39. Assuming that the payment process is successful, the user can access a specific site provided by the e-book store “B” to download the e-book “History of ABCD” at any desired time.

As described above, after transmitting order information on behalf of the user at the user terminal 10 through the e-book ordering unit 106 to the e-book store “B” server 20, the e-book sales agency server 100A does not further process confirmation of order or payment. Once the order information is accepted at the e-book store “B” server 20, the user terminal 10 and the server 20 of the e-book store “B” directly communicate with each other to confirm the order of purchasing the e-book “History of ABCD” and process payment of such e-book.

When the server 20 of the e-book store “B” ends a session with the user terminal 10, at S40, the e-book store “B” server 20 sends a payment result to the e-book sales agency system 100A. More specifically, the server 20 of the e-book store “B” sends the payment result including the order ID, information indicating completion of payment, and the amount of payment, to the e-book sales agency server 100A. In case the order is canceled or payment is not completed due to the other reasons, the server 20 of the e-book store “B” sends the payment result including the order ID and information indicating that payment is not completed to the e-book sales agency server 100A.

At S41, the payment confirmation unit 108 of the e-book sales agency server 100A confirms the payment result. More specifically, at S41, the payment confirmation unit 108 searches the order information including the order ID included in the payment result, which is stored at S28, and records information indicating whether payment is completed or not. Further, when the payment result indicates that payment is completed, the payment confirmation unit 108 reports the charge fee updater 109 with the paid amount. At S42, the charge fee updater 109 updates the charge fee, based on the reported information.

For example, when the reported information indicates completion of payment, the charge fee updater 109 updates charge fee information. When the reported information indicates incompletion of payment, the charge fee updater 109 does not update charge fee information.

The charge fee information in this embodiment is any information that can be used for calculating a charge fee, which is to be charged by the e-book sales agency to each e-book store in providing business platform for promoting e-book sales. A method of calculating such charge fee, or a way of charging such charge fee, may be previously determined, for example, based on application of such business platform. For the descriptive purposes, in this embodiment, it is assumed that the e-book sales agency charges a charge fee to each e-book store, based on a number of e-book purchase orders made by the e-book sales agency server 100A, and the total amount of payment.

FIG. 10 illustrates an example data structure of charge fee management table 800, which may be updated by the charge fee updater 109 based on the payment result received from each one of the e-book stores. As illustrated in FIG. 10, the charge fee management table 800 includes a “e-book store” field 801 for storing identification of e-book store, a “number of orders” field 802 for storing a number of purchase orders received by the e-book store, a “total sales” field 803 for storing total sales amount of the e-book store, a “service plan” field 804 for storing a service plan of the e-book store, and a “charge fee” field 805 for storing a charge fee to the e-book store.

For example, when the charge fee updater 109 receives the payment result from the e-book store, the charge fee updater 109 increments a value of the number of e-book sales in the field 802, which is associated with the e-book store ID of that e-book store that has sent such payment result, by one. The charge fee updater 109 further adds the amount of payment, which is obtained from the payment result, to the total sales value in the field 803. According to the updated values in the fields 802 and 803, the charge fee in the field 805 is updated according to the service plan in the field 804.

Examples of service plan include, but not limited to, a service plan in which a fixed fee is charged per one order of e-book purchase, and a service plan in which a predetermined rate of total e-book sales is charged. Alternatively, the e-book sales agency may charge a fee, which may be a monthly flat fee or a sales volume based fee, according to a contract with a specific e-book store that may differ from store to store.

In the above-described embodiment referring to FIGS. 1 to 10, the e-book sales agency provides the e-book store with business platform for promoting sales of e-books. More specifically, the e-book sales agency server 100A offers sales of an e-book associated with a paper book that the user currently owns at a special price (that is, at a discount price or even at free) to the user. To support such business platform, the e-book sales agency server 100A simplifies a process of ordering the e-book associated with the paper book.

### Second Embodiment

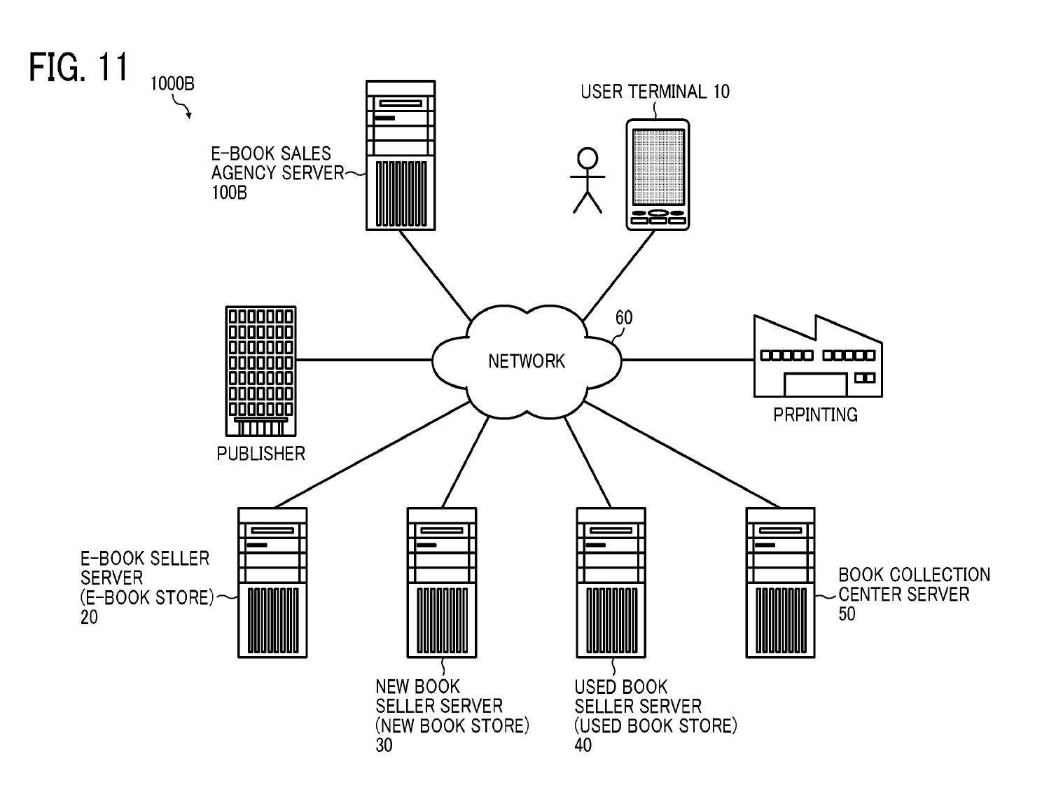

FIG. 11 is a schematic diagram illustrating a configuration of a network system 1000B, which includes an e-book sales agency system (server) 100B, the e-book seller server 20, a new book seller server 30, a used book seller server 40, and a book collection center server 50. The new book seller server 30 is a server of a paper book store that sells new books, such as books that are printed by a printing shop and bought from a publisher directly or indirectly. The used book seller server 30 is a server of a used paper book store that sells old (used) books that have been brought by the user. The book collection center server 50 is a server of a book collection center that collects used books from the user. The network system 1000B may further include a server of a publisher, and a server of a printing shop. These servers are connected through the network 60 such as the Internet or VPN to be communicable with one another. The servers in FIG. 11 may each be implemented by one computer or a plurality of computers. Further, any one of the servers and the user terminal in the network system 1000B could be located at any place, such as within one country, or over different countries. For simplicity, the e-book store sales agency system 100B may be referred to as the e-book store sales agency server 100A or the e-book sales agency, the e-book seller server 20 may be referred to as the e-book store, the new book seller server 30 may be referred to as the new book store, the used book seller server 40 may be referred to as the used book store, and the book collection center server 50 may be referred to as the book collection center.

More specifically, in the following embodiment illustrated in FIGS. 11 to 26, in addition to providing business platform described above referring to FIGS. 1 to 10 that offers a right to purchase an e-book at a special price (discount price including the free price) to the user who owns a paper book, the e-book sales agency offers business platform that offers a right to have an e-book at a special price (discount price including the free price) in exchange of a paper book, to the user who owns the paper book. If the special price is free, the user simply trades the paper book with the e-book.

In some cases, the user may want to exchange the paper book that the user currently owns with the e-book, if such exchange is available at a low price or at free. For example, the user may have many paper books that the user has already read, but the user feels reluctant to get rid of such paper books as the user may want to read in the future.

On the other hand, the used book store needs to collect used books. If the user is encouraged to sell the used book or even give the used book at free in exchange of the e-book, used books can be easily collected.

For the e-book store, as long as the user is encouraged to purchase the e-book, sales of e-books increase even at a special price.

The e-book store thus benefits from such business platform as sales of e-books increase or at least promoted. Further, the used book store benefits from such business platform as collection of used books increases.

The e-book sales agency may charge a fee for providing such business platform to each e-book sore or to each used book store.

As described below, the business platform provided by the network system 1000B is operated and maintained by the e-book sales agency in cooperation with one or more partners selected from the publisher, printing shop, e-book store, new book store, used book store, and book collection center.

Since the hardware configuration of each server and the user terminal 10 of the network system 1000B is the same as that of the network system 1000A of FIGS. 2A and 2B, description thereof is omitted.

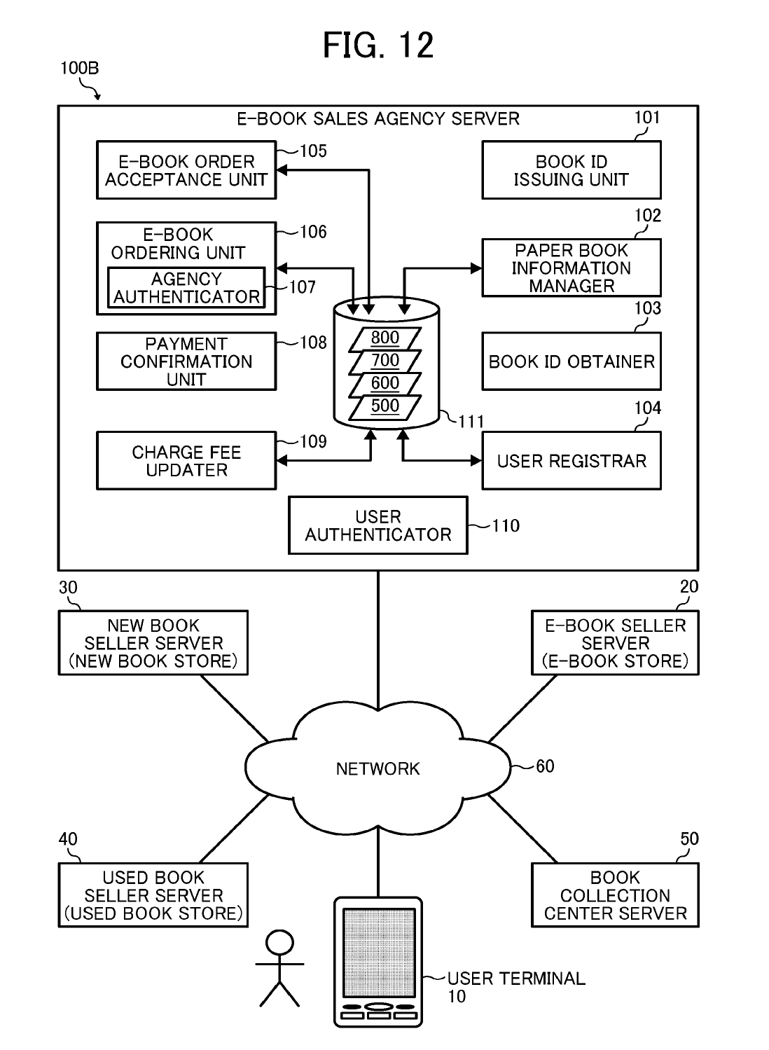

Referring to FIG. 12, a functional configuration of the e-book sales agency server 100B is explained according to the embodiment of the present invention.

As illustrated in FIG. 12, the e-book sales agency server 100B includes a book ID issuing unit 101, a paper book information manager 102, a book ID obtainer 103, the user registrar 104, the e-book order acceptance unit 105, the e-book ordering unit 106, the payment confirmation unit 108, the charge fee updater 109, the user authenticator 110, and the database 111.

The book ID issuing unit 101 issues a book ID, which is identification assigned to each paper book for uniquely identifying the paper book. The paper book information manager 102 centrally manages information regarding the paper book such as the book ID. The book ID obtainer 103 obtains a book ID that is assigned to the paper book, from the user terminal 10 operated by the user who requests to purchase an e-book. The user registrar 104, the e-book order acceptance unit 105, the e-book ordering unit 106, the agency authenticator 107, the payment confirmation unit 108, the charge fee updater 109, and the user authenticator 110 are substantially similar in function to the corresponding units in FIG. 3.

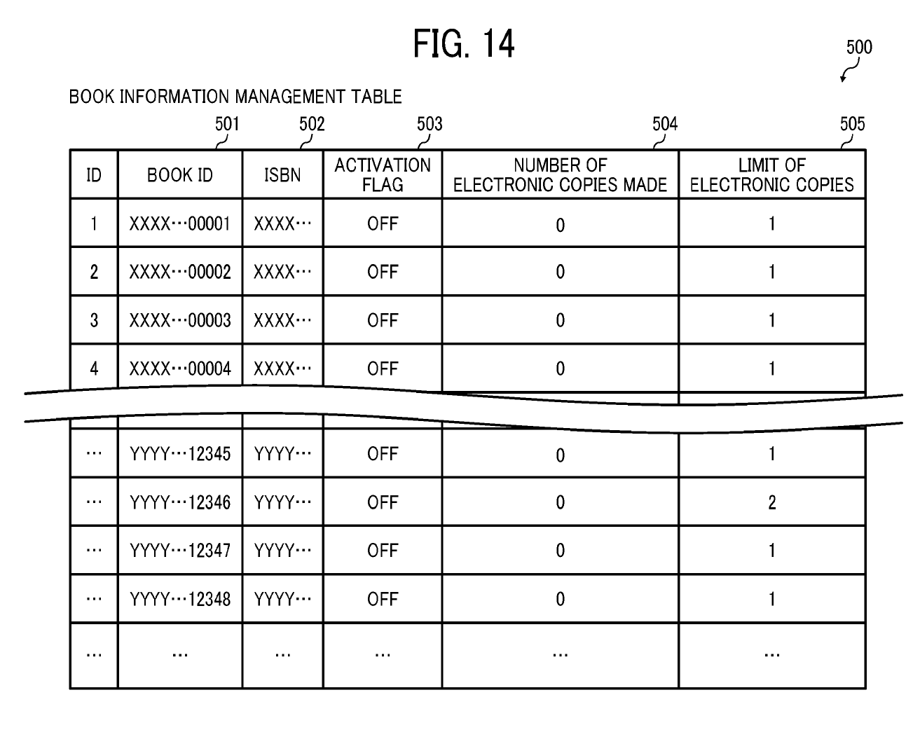

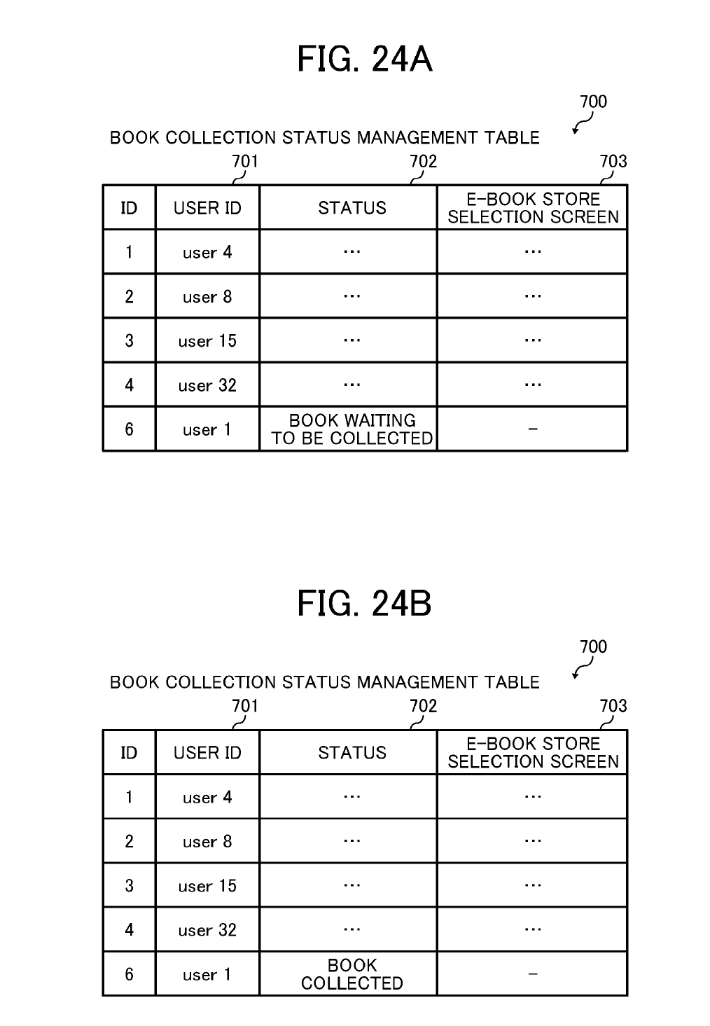

The database 111 in this embodiment includes, in addition to the user information registration table 600 and the charge fee management table 800, a book information management table 500 (FIG. 14) and a book collection status management table 700 (FIG. 24).

As described above referring to FIG. 3, the above-described units in FIG. 12 are implemented by a plurality of instructions that are generated by the processor 200 according to a program stored on any desired memory such as the RAM 204. The database 111 is implemented by the processor 200 in cooperation with any desired memory such as the ROM 202 or the auxiliary memory 206.

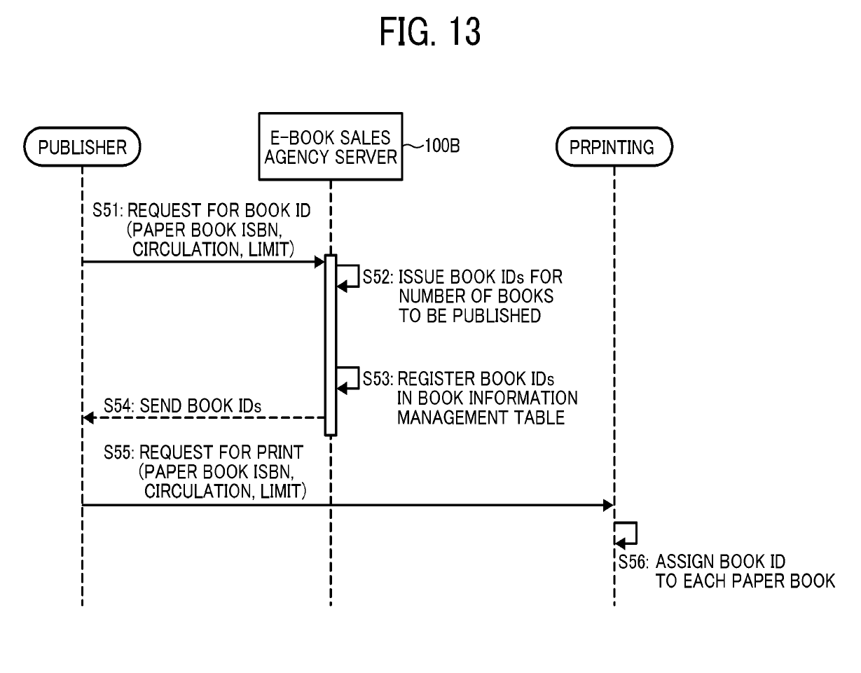

Referring now to FIG. 13, operation of assigning a book ID to each paper book to be published, performed by the e-book sales agency server 100B in cooperation with the publisher server and the printing shop server, is explained according to an embodiment of the present invention.

Before requesting the printing shop to print paper books, at S51, a server of the publisher requests the e-book sales agency server 100B to issue a book ID to be assigned to each paper book to be printed. More specifically, the publisher server transmits a book ID issuing request to the e-book sales agency server 100B, which includes ISBN of the paper book, the number of copies of the paper book (circulation), and an upper limit of electronic copies allowed for the paper book. The publisher may send such request through an entry form provided by the e-book sales agency server 100B, or through an email having such request to an email address given by the e-book sales agency.

In this embodiment, ISBN is used as an example of identification for identifying a title of the paper book. The number of copies of the paper book, which may be referred to as circulation, is a number of paper books to be printed for each book title, and can be expressed as an actual number of paper books to be printed or any symbol that can be interpreted by the printing shop as an actual number of paper books to be printed. The upper limit indicates an upper limit of electronic copies (that is, the number of e-books) that are allowed for one paper book. In this embodiment, the publisher presets the value of an upper limit for each book title according to a contract with the e-book sales agency. When the publisher does not allow any number of electronic copies, the publisher sets the upper limit to “0”.

In response to receiving the book ID issuing request, at S52, the book ID issuing unit 101 of the e-book sales agency server 100B issues a book ID for each paper book to be published, for each book title identified with the same ISBN. The number of book IDs to be issued is equal to the number of copies of the paper book to be printed for each book title. For simplicity, each book may be identified with a combination of ISBN and a book ID. In particular, a serial number of the book ID follows a serial number of the ISBN. In order to issue a book ID for each one of 10 million copies of paper book, at least 7 digits are required.

At S53, the paper book information manager 102 of the e-book sales agency server 100B registers, for each paper book to be printed, the book ID that is issued by the book ID issuing unit 101 in the book information management table 500, in association with information regarding that paper book.

FIG. 14 is an example data structure of the book information management table 500. The book information management table 500 includes a “book ID” field 501 for storing the book ID of each paper book, a “ISBN” field 502 for storing the ISBN of the book with the same title, a “activation flag” field 503 for storing a value (on/off) of activation flag, a “number of electronic copies made” field 504 for storing a number of electronic copies that are made for the paper book with the same ISBN, and a “limit of electronic copies” field 505 for storing an upper limit of electronic copies that are permitted for the paper book with the same ISBN. The activation flag in this example indicates availability of the e-book sales agency service, which is a service to exchange the paper book with the e-book.

The paper book information manager 102 adds records in the book information management table 500 for all of book IDs that are issued. When newly registering a paper book, the paper book information manager 102 adds a record, which stores the book ID that is issued at S52 in the field 501, the ISBN received at S51 in the field 502, the activation flag value “OFF” in the field 503, the value “0” of electronic copies in the field 504, and the value of upper limit that is received at S51 in the field 505.

At 54, the paper book information manager 102 transmits the paper book IDs, which are issued, to the publisher server.

At S55, the publisher server transmits a request for printing the paper book, to the printing shop server. The printing request includes the ISBN of the paper book, the number of copies of the paper book (circulation), and the book IDs to be assigned to the paper books. The publisher may send such request through an entry form provided by the e-book sales agency server 100B, or through an email having such request to an email address given by the e-book sales agency.

At S56, the printing shop server, which receives the printing request, prints the paper books while assigning each paper book with the book ID that is transmitted from the publisher server. For example, a specific book ID may be directly printed on a cover of the paper book or any page of the paper book. Alternatively, a seal having a specific book ID printed thereon may be put on the cover or any page of the paper book.

Further, while the book ID may be printed in the form of string of numbers, the book ID is preferably printed in the form of code such that the book ID can be automatically read by a code reader such as a dedicated code reader capable of reading such book ID. Coding of book ID may be performed by any one of the printing shop, the publisher, and the e-book sales agency, as long as the code of the book ID is notified to the printing shop.

In alternative to printing the book ID in the form of text (string of numbers) or code (such as QR code), the book ID may be embedded as a dot pattern, which is made invisible to the human eye.

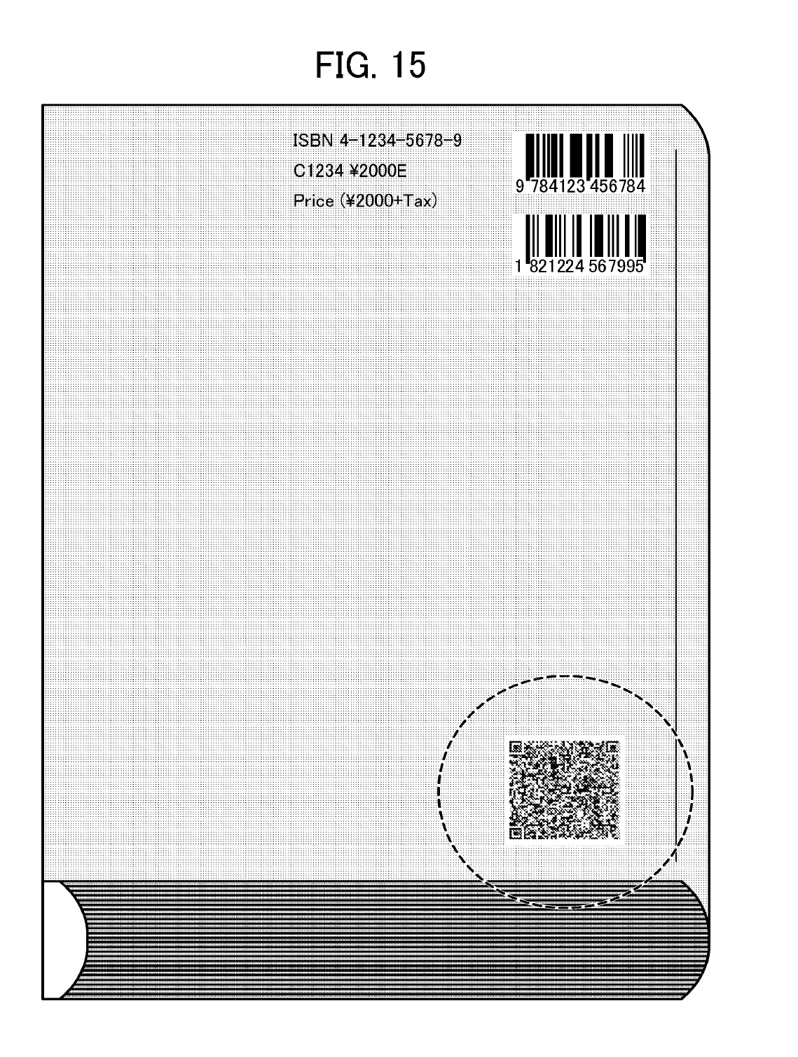

FIG. 15 is an illustration of an example paper book printed with a book ID code. In this example of FIG. 15, the book ID is printed at a lower right side of a backside cover of the paper book in the form of QR code. In alternative to QR code, any other desired two-dimensional code or one-dimensional code such as a barcode may be used as the book ID code. Further, the book ID code may be printed at any desired portion of the paper book, such as on the frontside cover, backside cover, etc.

The paper books that are printed by the printing shop are supplied to new book stores to be purchased by a user.

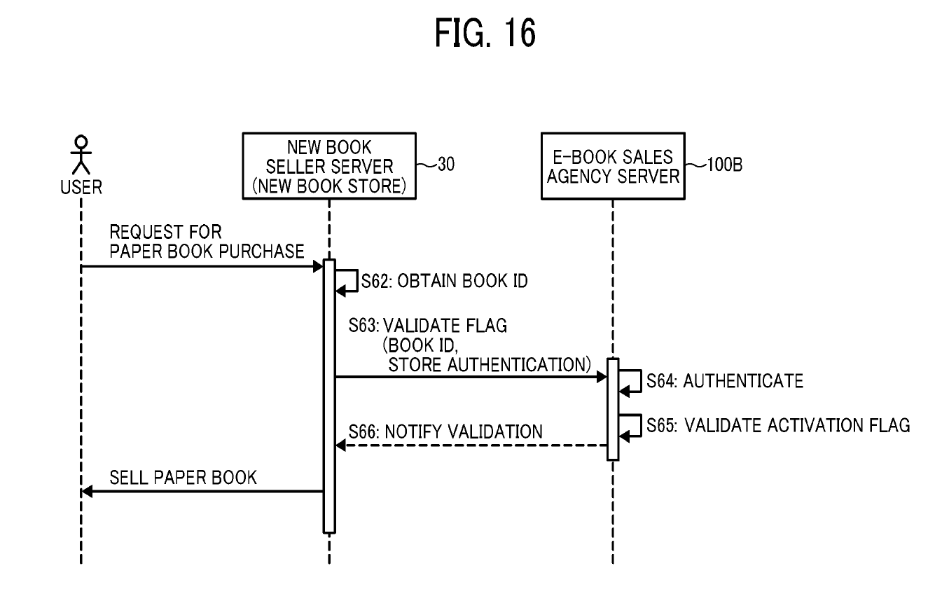

Referring now to FIG. 16, operation of managing the activation flag of the paper book, performed by the e-book sales agency server 100B in cooperation with the new book seller server 30, is explained according to an embodiment of the present invention. In the following, it is assumed that the user physically visits the new book store and purchases a paper book at the new book store. Alternatively, the user may access the new book seller server 30 on the Internet using the user terminal 10 to purchase the paper book from the new book store on the Internet.

The user selects a paper book for purchase, and brings the paper book to a cashier.

As the cashier scans the QR code printed on the paper book with a dedicated QR code reader, at S62, the new book seller server 30 obtains the book ID, which is decoded from the scanned QR code.

At S63, the new book seller server 30 sends a request for validating the activation flag, to the e-book sales agency server 100B. The activation flag validation request includes the obtained book ID and authentication information of the new book store.

At S64, the paper book information manager 102 of the e-book sales agency server 100B authenticates the new book store using the authentication information of the new book store, which is included in the activation flag validation request. In this embodiment, the e-book sales agency server 100B previously stores authentication information, such as the user ID and the password, of the new book store.

When the new book store is authenticated, at 565, the paper book information manager 102 of the e-book sales agency server 100B searches the book information management table 500 (FIG. 14) using the book ID included in the activation flag validation request as a search key to identify a record for that book ID, and changes the activation flag (field 503) in the identified record from “OFF” to “ON”.

At S66, the paper book information manager 102 of the e-book sales agency server 100B reports the new book seller server 30 that validation of activation flag is completed. The new book seller server 30 displays a message indicating validation of activation flag on a display through the input/output device OF 208. After confirmation of such message, the cashier at the new book store sells the paper book to the user at a regular price.

In the above-described operation, in alternative to decoding the QR code to obtain the book ID at the new book store, the e-book sales agency server 100B may decode the QR code to obtain the book ID of the paper book. In such case, the cashier at the new book store takes a picture of the QR code printed on the paper book, and sends the flag validation request including the QR code image and the authentication information of the new book store, to the e-book sales agency server 100B.

In this embodiment, operation of registering a user at the e-book sales agency server 100B and e-book stores to be used by the user is performed in a substantially similar manner as described above referring to FIGS. 4 and 5.

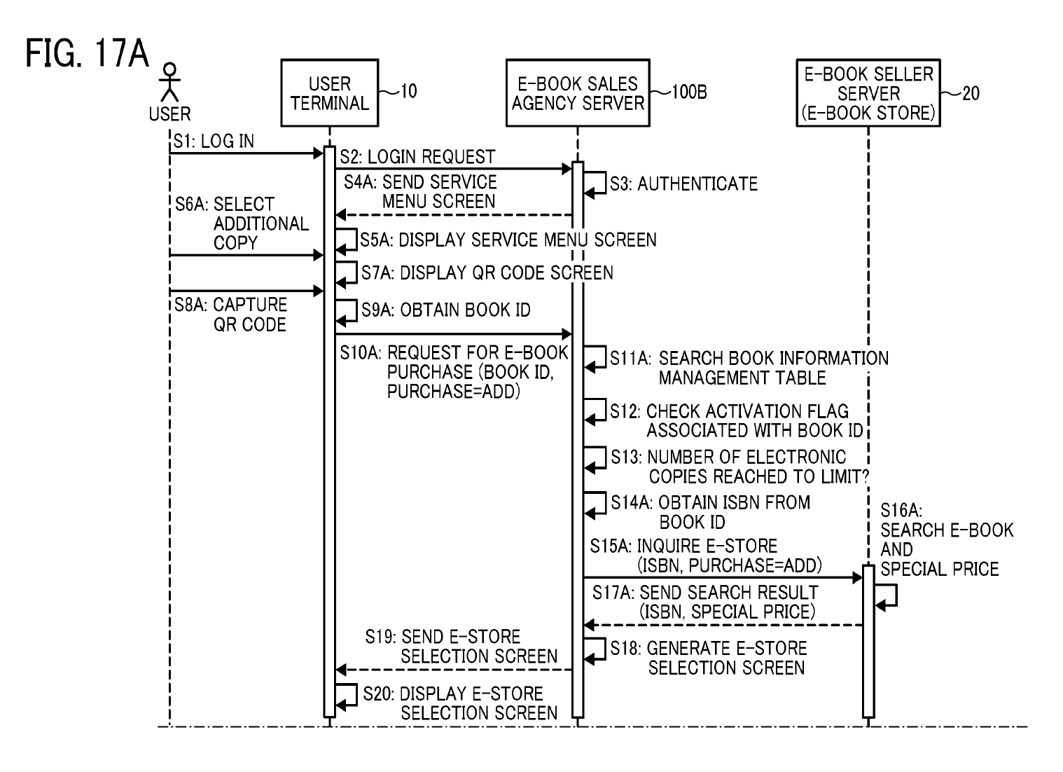

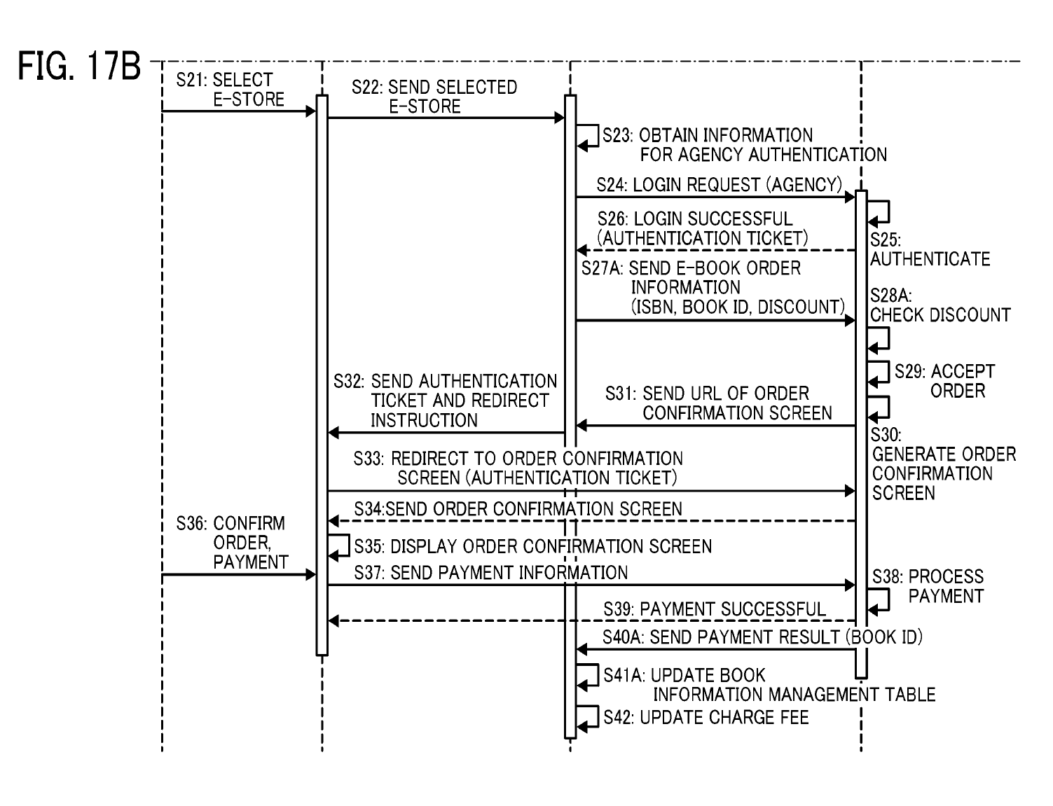

Referring now to FIG. 17, operation of processing an order of purchasing an e-book associated with a paper book, is explained according to an embodiment of the present invention. In this embodiment, it is assumed that the user requests to purchase a digital content version (“e-book”) of a paper book that the user previously bought at the new book store as described above referring to FIG. 16.

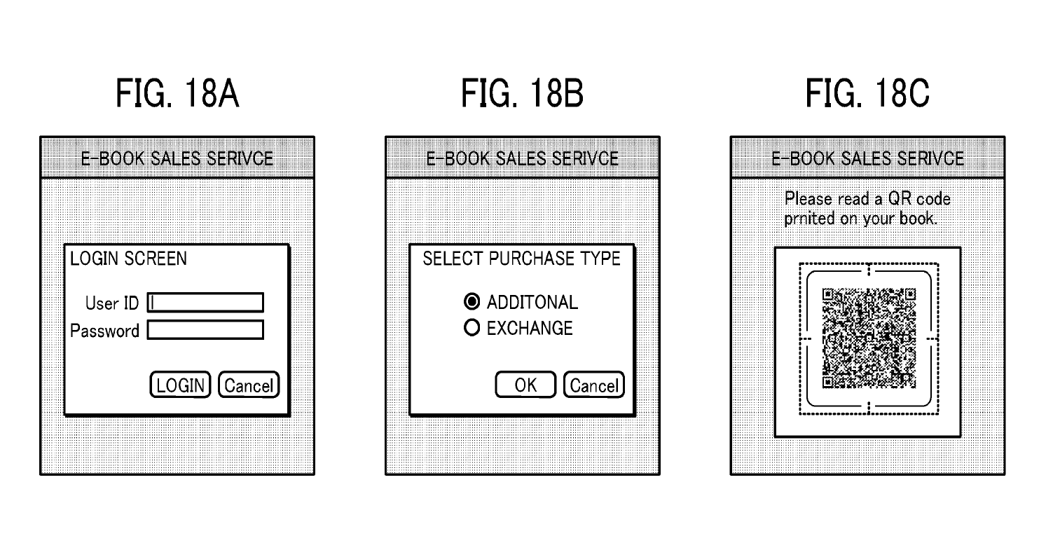

S1 to S3 are performed in a substantially similar manner as described above referring to S1 to S3 of FIG. 6 and FIG. 7A. More specifically, the user at the user terminal 10 inputs a user ID and a password on an example login screen as illustrated in FIG. 18A, and the user terminal 10 transmits the input information to request for user authentication to the e-book sales agency server 100B. When authentication is successful at S3, at S4A, the e-book order acceptance unit 105 transmits a service menu screen to the user terminal 10.

At S5A, the user terminal 10 controls the display 308 to display the service menu screen, which is received from the e-book sales agency server 100B, to the user. FIG. 18B is an example service menu screen, which requests the user at the user terminal 10 to select one of services that are listed. In this embodiment, the user can select, through a radio button, either “Additional copy” or “Exchange”. In this embodiment, the option “Additional copy” is selected when the user desires to have an e-book in addition to the paper book that the user currently owns. The option “Exchange” is selected when the user desired to have an e-book in exchange of the paper book that the user currently owns.

Assuming that the user terminal 10 receives a user input that selects the “Additional copy” and the “OK” key at S6A, at S7A, the user terminal 10 further causes the display 308 to display a QR code screen as illustrated in FIG. 18C.

In response to a user instruction, at SBA, the user terminal 10 captures an image of a QR code printed on the paper book that the user has bought at the new book store using a camera of the user terminal 10.

At S9A, the processor 300 of the user terminal 10 decodes the captured QR code into a book ID.

At S10A, the processor 300 of the user terminal 10 generates a request for purchasing the e-book associated with the paper book having the obtained book ID, and transmits the e-book purchase request to the e-book sales agency server 100B. The e-book purchase request includes the obtained book ID and information indicating the selected service (in this example, the additional copy).

At S11A, the e-book order acceptance unit 105 searches the book information management table 500 (FIG. 14) using the book ID as a search key to obtain a record of the paper book having the obtained book ID.

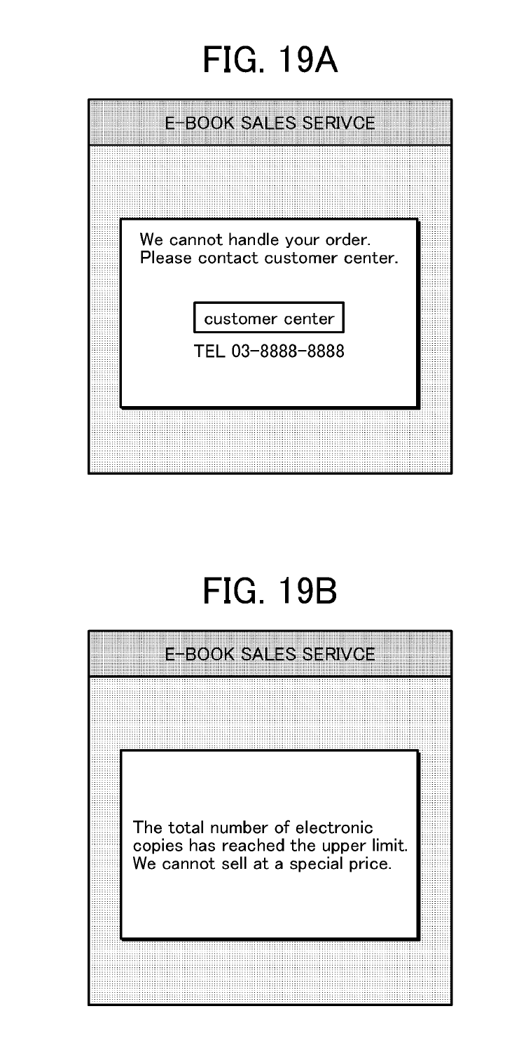

At S12, the e-book order acceptance unit 105 checks whether the activation flag in the field 503 has the value “ON” on the specified record for the paper book having the obtained book ID. When it is determined that the activation flag does not have the value “ON”, the e-book order acceptance unit 105 generates a message indicating that an order from the user cannot be accepted, and transmits the generated message to the user terminal 10. The user terminal 10 displays the received message on the display 308. FIG. 19A illustrates an example screen having such message indicating that the order cannot be accepted.

As described above, in this embodiment, the e-book sales agency server 100B keeps the activation flag of the paper book to be “OFF” as long as the paper book is at the new book store. Accordingly, even if a person with the smart phone 10 at the new book store captures an image of a QR code printed on the paper book before purchasing such paper book, and transmits the captured QR code image to the e-book sales agency server 100B to request for additional copy of the paper book, the e-book sales agency server 100B will reject such request based on determination that the activation flag is set to “OFF” for that paper book. The activation flag thus prevents any person from obtaining a copy of an e-book without purchasing a paper book.

Referring back to S12, when the activation flag associated with the book ID included in the e-book purchase request has the value “ON”, operation proceeds to S13. At S13, the e-book order acceptance unit 105 searches the book information management table 500 (FIG. 14) using the book ID included in the e-book purchase request as a search key to determine whether the number of electronic copies made (field 504) reaches an upper limit of electronic copies that are allowed (field 505). When the number of electronic copies made reaches the upper limit, the e-book order acceptance unit 105 generates a message indicating that the e-book cannot be sold at a special price, and transmits such message to the user terminal 10. The user terminal 10 causes the display 308 to display the received message. FIG. 19B illustrates an example screen including such message.

When the number of electronic copies made does not reach the upper limit, at S14A, the e-book order acceptance unit 105 obtains an ISBN of the paper book, which is associated with the book ID included in the e-book purchase request. More specifically, the e-book order acceptance unit 105 extracts first 13 digits of numbers, from a sequence of numbers, as the ISBN. The e-book order acceptance unit 105 generates a request that inquires for the e-book associated with the paper book having the obtained ISBN, and transmits such e-book request to the servers 20 of one or more e-book stores that the user at the user terminal 10 has previously registered. The e-book request includes the ISBN and the selected service indicating, in this example, that an additional copy is to be purchased. S15A is performed in a substantially similar manner as described above referring to S15 of FIG. 6.

At S16A, the e-book seller server 20 of each of the e-book stores that receives the e-book request searches for an ISBN assigned to the e-book of the paper book, using the ISBN of the paper book that is included in the e-book request. Using the ISBN of the e-book associated with the paper book, the e-book seller server 20 searches a special price of the e-book having the obtained ISBN. This special price is preset according to a type of service such as whether to purchase an additional copy (a copy of e-book), or to exchange an e-book with the paper book.

At S17A, the e-book seller server 20 of each of the e-book stores sends the search result including the ISBN and the special price of the e-book that is associated with the paper book, to the e-book sales agency server 100B.

S18, S19, and S20 are performed in a substantially similar manner as described above referring to S18, S19, and S20 of FIG. 6.

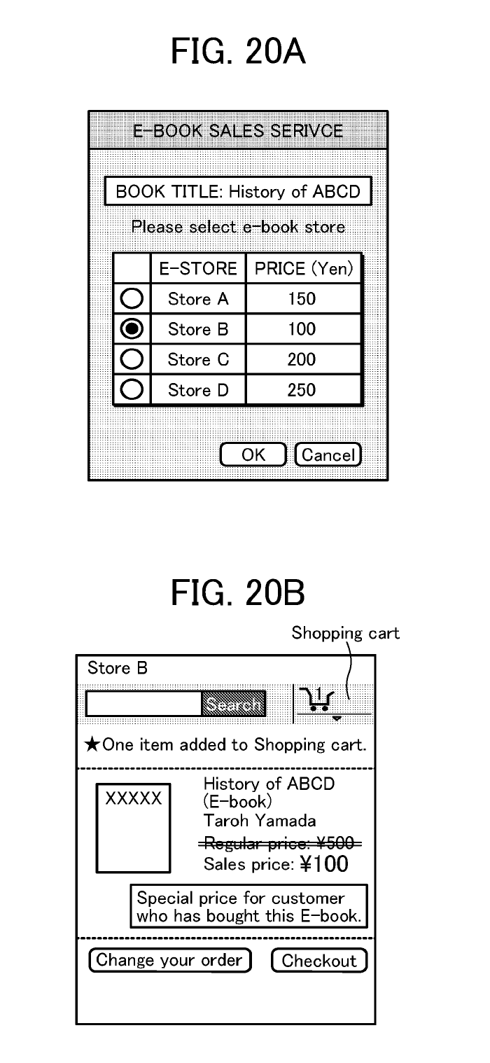

FIG. 20A is an example e-book store selection screen, which lists four e-book stores A, B, C, and D with a special price of the e-book that is associated with the paper book that the user currently owns. With this screen, the user at the user terminal 10 is able to select one of the e-book stores that the user wants to purchase the e-book from, for example, based on the price of the e-book.

When the user selects the e-book store “B” that offers the e-book for the lowest price, and selects the “OK” key, at S21 (FIG. 17B), the user terminal 10 receives the user selection of the e-book store. At S22, the user terminal 10 sends the selected e-book store “B” to the e-book sales agency server 100B.

S23 to S26 of accessing the e-book store “B” on behalf of the user is performed in a substantially similar manner as described above referring to S23 to S26 of FIG. 6.

At S27A, the e-book ordering unit 106 generates order information including the ISBN of the e-book (In this example, the title “History of ABCD”), the book ID of the paper book, and information regarding the special price, and transmits the order information to the e-book store “B” server 20. In this example, the information regarding the special price includes information indicating the selected service (in this example, the purchase of additional copy), and a certificate for certifying that the login user has a right to purchase the e-book at the special price.

At S28A, the processor 200 of the e-book store “B” server 20 checks the certificate and the selected service (the purchase of additional copy), from the information regarding the special price that is received from the e-book sales agency server 100B.

At S29, the processor 200 of the e-book store “B” accepts and processes the order of purchasing the e-book having the ISBN that is included in the order information received from the e-book sales agency server 100B. More specifically, the e-book store “B” server 20 accepts an order of purchasing the e-book (with the title “History of ABCD” and a regular price of 500 Yen) at the special price of 100 Yen. In this example, processing the order corresponds to an action of placing a specific item (that is, the e-book) in a shopping cart of the user at the user terminal 10.

S30 to S39 are performed in a substantially similar manner as described above referring to S30 to S39 of FIG. 6. In this example, however, an example order confirmation screen indicates that the user can purchase the e-book at a special price.

FIG. 20B illustrates an example order confirmation screen for display at the user terminal 10. The order confirmation screen of FIG. 20B displays an image reflecting the e-book store “History of ABCD” (e-book), and a message indicating a copy of e-book is available for the user who owns this book at a special price of 100 Yen.

Further, in this example, the book ID is used as the order ID, as the book ID is unique to each paper book.

For example, at S40A, the server 20 of the e-book store “B” sends the book ID, the payment result including information indicating completion of payment, and the amount of payment, to the e-book sales agency server 100B. In case the order is canceled or payment is not completed due to the other reasons, the server 20 of the e-book store “B” sends the payment result including the book ID and information indicating that payment is not completed to the e-book sales agency server 100B.

At S41A, the payment confirmation unit 108 of the e-book sales agency server 100B confirms the payment result, and updates the book information management table 500 (FIG. 14) to reflect the payment result. More specifically, when the payment result indicates incompletion of payment, the payment confirmation unit 108 does not update the book information management table 500. When the payment result indicates completion of payment, the payment confirmation unit 108 searches the book information management table 500 using the book ID included in the payment result as a search key to specify a record of the paper book, and increments the number of electronic copies made that is associated with the obtained paper book ID (field 504) by one.

At S42, the charge fee updater 109 updates the charge fee, based on the reported information, in a substantially similar manner as described above referring to FIG. 6.

As described above, in this embodiment referring to FIGS. 11 to 20, the e-book sales agency provides the e-book store with business platform for promoting sales of e-books. More specifically, the e-book sales agency server 100B offers sales of an e-book associated with a paper book that the user currently owns at a special price (that is, a discount price or free) to the user who has bought that paper book. The e-book sales agency server 100B further simplifies a process of ordering the e-book associated with the paper book.

Moreover, through assigning the book ID to each paper book, transaction of the paper book can be easily tracked.

The above-described business platform may be used by a user who has bought a new paper book at the new book store, but also by a user who has bought a used paper book at a used book store, as described below. For simplicity, the used paper book is referred to as the used book.

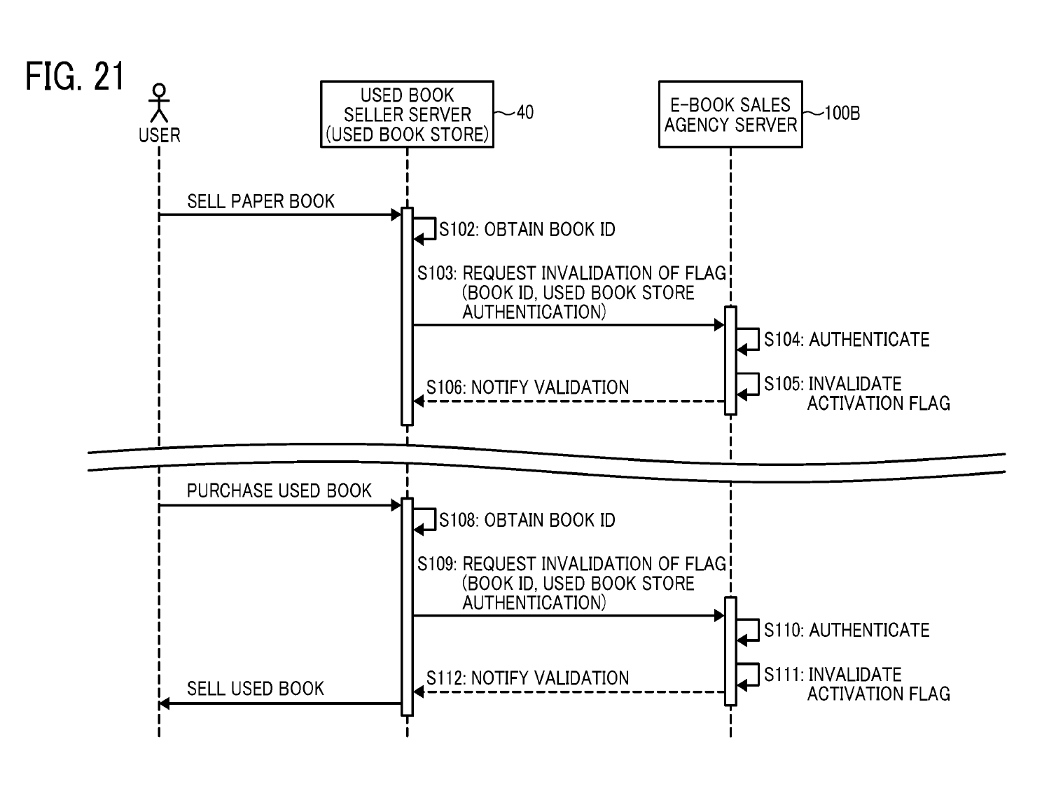

Referring to FIG. 21, operation of managing transaction of used book, performed by the e-book sales agency server 100B in cooperation with the used book seller server 40, is explained according to an embodiment of the present invention. In the following, it is assumed that the user physically visits the used book store and sells or purchases a used book at the used book store. Alternatively, the user may access the used book seller server 40 on the Internet using the user terminal 10 to sell or purchase the used book from the used book store on the Internet.

S102 to S106 are performed when the user brings a used book to a cashier (staff) of the used book store to sell the used book.

As the cashier scans the QR code printed on the used book with a dedicated QR code reader, at S102, the used book seller server 40 obtains the book ID, which is decoded from the scanned QR code.

At 5103, the used book seller server 40 sends a request for invalidating the activation flag, to the e-book sales agency server 100B. The activation flag invalidation request includes the obtained book ID and authentication information of the used book store. The authentication information of the used book store, such as the user ID and the password, may be stored in a memory of the used book seller server 40.

At S104, the paper book information manager 102 of the e-book sales agency server 100B authenticates the used book store using the authentication information of the used book store, which is included in the activation flag invalidation request. In this embodiment, the e-book sales agency server 100B previously stores authentication information, such as the user ID and the password, of the used book store.

When the used book store is authenticated, at S105, the paper book information manager 102 of the e-book sales agency server 100B searches the book information management table 500 (FIG. 14) using the book ID included in the activation flag invalidation request as a search key to identify a record for that book ID, and changes the activation flag (field 503) in the identified record from “ON” to “OFF”.

At S106, the paper book information manager 102 of the e-book sales agency server 100B reports the used book seller server 40 that invalidation of activation flag is completed. The used book seller server 40 displays a message indicating invalidation of activation flag on a display through the network OF 210. After confirmation of such message, the cashier (or staff) at the used book store puts the used book on the store shelf.

S108 to S112 are performed when a user, which is assumed to be different than the user who has sold the used book in the above-described operation, purchases the used book from the used book store.

The user brings the used book to the cashier at the used book store to purchase the used book.

As the cashier scans the QR code printed on the used book with a dedicated QR code reader, at S108, the used book seller server 40 obtains the book ID, which is decoded from the scanned QR code.

At S109, the used book seller server 40 sends a request for validating the activation flag, to the e-book sales agency server 100B. The activation flag validation request includes the obtained book ID and authentication information of the used book store.

At S110, the paper book information manager 102 of the e-book sales agency server 100B authenticates the used book store using the authentication information of the used book store, which is included in the activation flag validation request.

When the used book store is authenticated, at S111, the paper book information manager 102 of the e-book sales agency server 100B searches the book information management table 500 (FIG. 14) using the book ID included in the activation flag validation request as a search key to identify a record for that book ID, and changes the activation flag (field 503) in the identified record from “OFF” to “ON”.

At S66, the paper book information manager 102 of the e-book sales agency server 100B reports the used book seller server 40 that validation of activation flag is completed. The used book seller server 40 displays a message indicating validation of activation flag on a display through the network I/F 210. After confirmation of such message, at S67, the cashier at the used book store sells the paper book to the user.

The user who has bought the used book as described above may purchase an e-book associated with the used book (paper book), through the e-book sales agency, as described above referring to FIG. 17.

In this embodiment, the e-book sales agency server 100B keeps the activation flag of the used paper book to be “OFF” as long as the used book is at the used book store. This prevents any person from obtaining a copy of e-book without purchasing the used paper book.

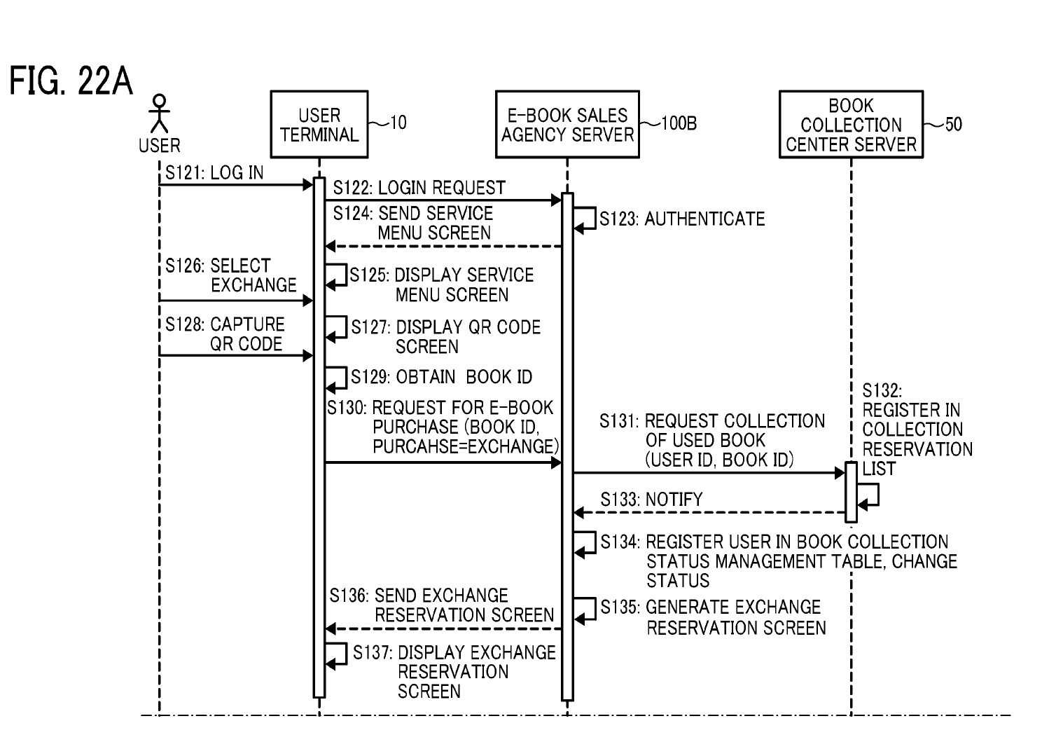

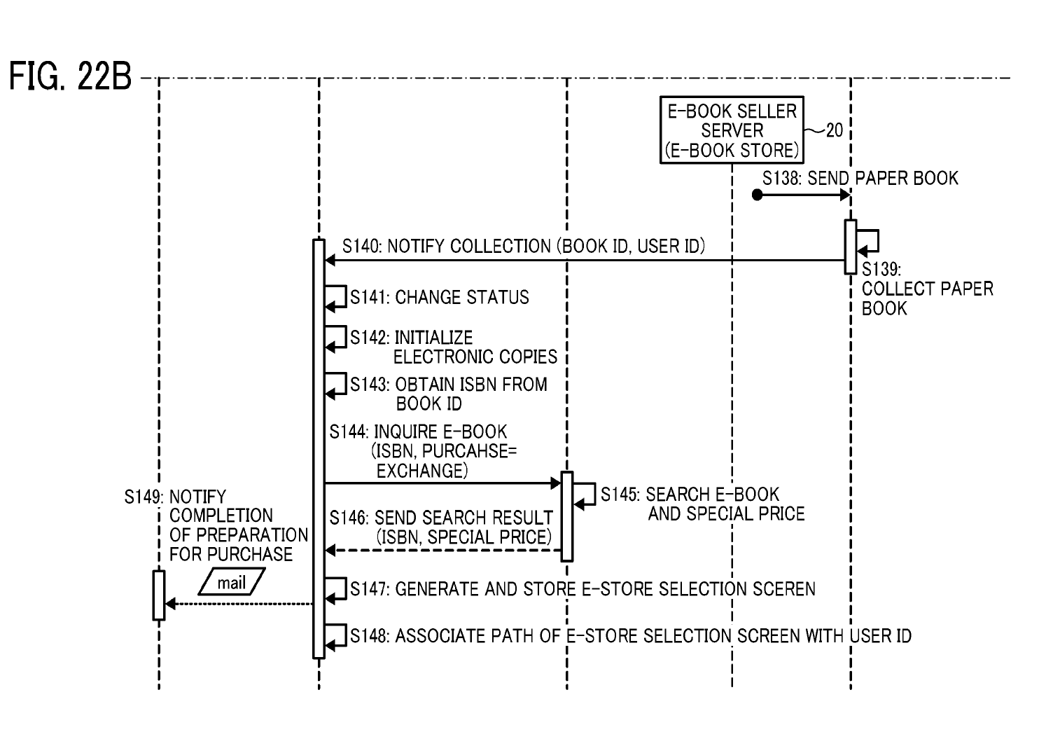

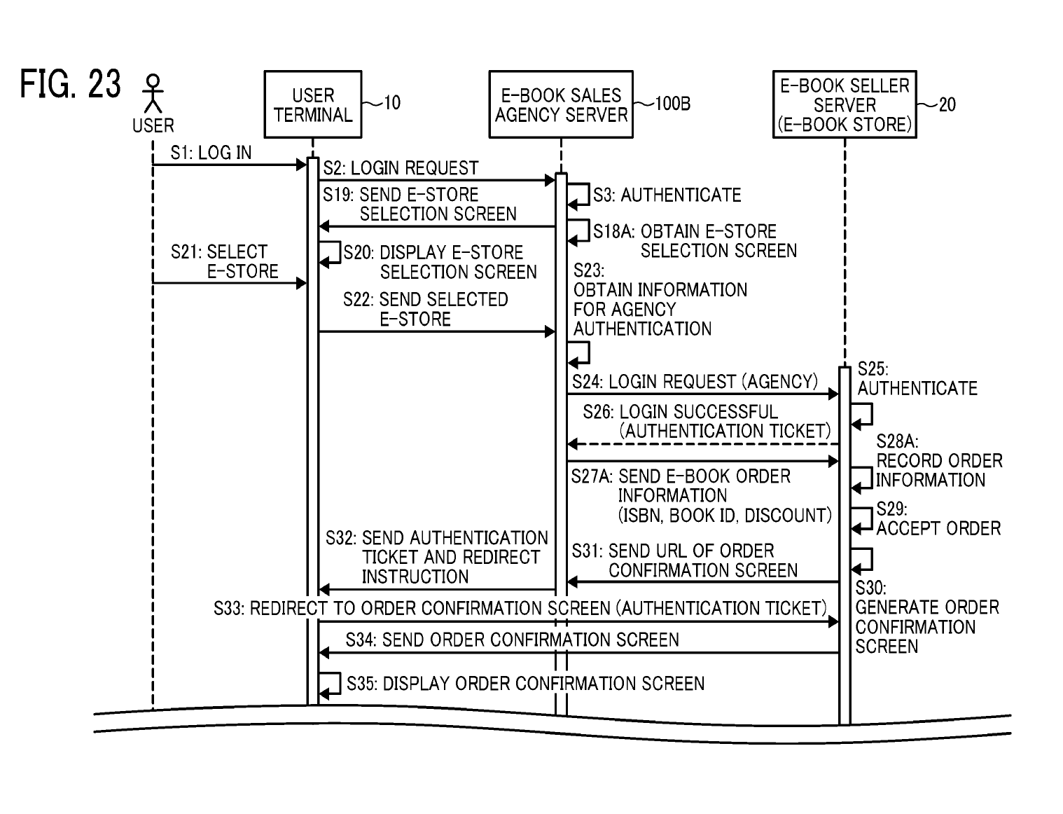

In any one of the above-described embodiments referring to FIGS. 6 and 17, the user purchases an e-book associated with the paper book that the user currently owns. Alternatively, the user may choose to exchange the paper book with an e-book, which is another service selectable by the user, as described below referring to FIGS. 22 and 23. FIG. 22 illustrates operation of collecting a paper book (used book) in response to a request for exchanging the paper book with an e-book according to an embodiment of the present invention.

S121 to S125 are performed in a substantially similar manner as described above referring to S1 to S3, S4A, and S5A of FIG. 17.

In this example, the user terminal 10 receives a user input that selects the “Exchange” and the “OK” key at S126 on the example service menu screen of FIG. 18B. At S127, the user terminal 10 further causes the display 308 to display the QR code screen as illustrated in FIG. 18C.

At 128 and S129, the user terminal 10 captures an image of a QR code printed on the paper book, and decodes the captured QR code into a book ID, as described above referring to S8A and S9A of FIG. 17.

At S130, the user terminal 10 generates a request for purchasing the e-book in exchange of the paper book having the obtained book ID, and transmits the e-book purchase request to the e-book sales agency server 100B. The e-book purchase request includes the obtained book ID and information indicating the selected service (in this example, the exchange).

At S131, the e-book order acceptance unit 105 generates a request for collecting the paper book to the book collection center server 50. The paper book collection request includes the user ID of the login user and the book ID included in the e-book purchase request.

At S132, the book collection center server 50 stores the book ID and the user ID in association with each other, in a collection reservation list. At 5133, the book collection center server 50 reports the e-book sales agency server 100B that reservation of paper book collection is completed.

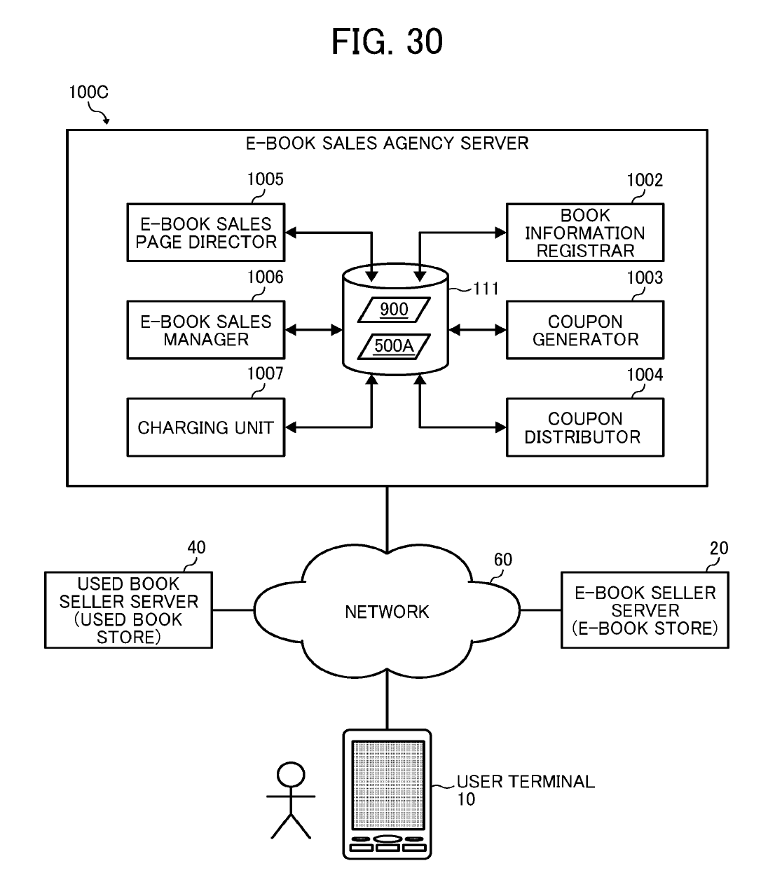

At S134, the e-book order acceptance unit 105 of the e-book sales agency server 100B registers the user ID of the login user in the book collection status management table 700 of FIG. 24. The book collection status management table 700 includes a “user ID” field 701 for storing the user ID, a “status” field 702 for storing a book collection status, and a “e-book store selection screen” field 703 for storing a path of an e-book store selection screen. At S134, as illustrated in FIG. 30A, the e-book order acceptance unit 105 stores the user ID “user1” of the login user in the field 701, and the status “waiting to be collected” in the field 702 for the user ID “user1”.

The e-book order acceptance unit 105 generates an exchange reservation screen at S135, and sends the exchange reservation screen to the user terminal 10 at 5136. At 5137, the user terminal 10 causes the display 308 to display the exchange reservation screen received from the e-book sales agency server 100B.

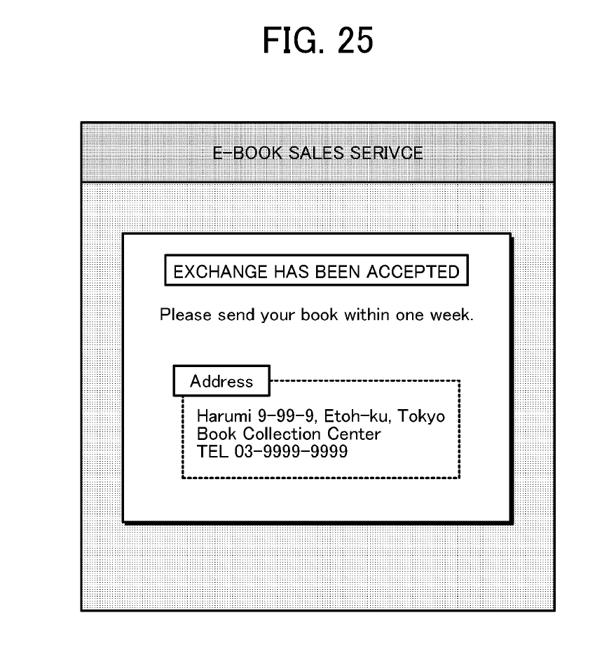

FIG. 25 illustrates an example exchange reservation screen, which indicates that exchange of the paper book is accepted, with information regarding an address to send the paper book.

Based on this information, the user will send the paper book to the used book collection center. Referring to FIG. 22B, as a staff at the book collection center receives the paper book from the user at S138, the staff scans the QR code printed on the paper book with a dedicated QR code reader. At S139, the book collection center server 50 obtains the book ID, which is decoded from the scanned QR code, and updates the collection reservation list to indicate that collection of the book having the obtained book ID is completed.

At S140, the book collection center server 50 transmits notification indicating that collection of the used book is completed to the e-book sales agency server 100B, which includes the book ID of the used book and the user ID as obtained from the collection reservation list.

At S141, the e-book ordering acceptance unit 105 of the e-book sales agency server 100B searches the book collection status management table 700 of FIG. 24, using the user ID included in the notification. More specifically, as illustrated in FIG. 24B, the book collection center server 50 changes the book collection status in the field 702 for the obtained user ID, from “book waiting to be collected” to “book collected”. Further, at S142, the e-book ordering acceptance unit 105 initializes the number of electronic copies (field 504), which is associated with the book ID included in the notification. Accordingly, the number of electronic copies is reset to “0”.

At S143, the e-book ordering unit 105 of the e-book sales agency server 100B obtains the ISBN using the obtained book ID of the collected used book. At S144, the e-book order acceptance unit 105 generates a request that inquires for the e-book associated with the collected used book having the obtained ISBN, and transmits such e-book request to the servers 20 of one or more e-book stores that the user at the user terminal 10 has previously registered. The e-book request includes the ISBN and the selected service indicating, in this example, that the used book is exchange with the e-book. S144 is performed in a substantially similar manner as described above referring to S15 of FIGS. 6.

S145 and S146 are performed in a substantially similar manner as described above referring to S16A and S17A of FIG. 17.

At S147, the e-book order acceptance unit 15 generates and stores an e-book selection screen based on the search result received from each one of the e-book seller servers 20. At S148, the e-book order acceptance unit 15 further refers to the book collection status management table 700, to store a path of the e-book selection screen in the field 703 that is associated with the user ID “user1” of the login user.

At S149, the e-book order acceptance unit 105 searches the user information registration table 600 (FIG. 5) using the user ID “user1” as a search key to obtain the email address (user1@email.com), and sends an email with a message indicating that an e-book can be purchased to the obtained email address.

Referring now to FIG. 23, operation of processing an order of purchasing an e-book associated with the paper book that has been collected, is explained according to the embodiment of the present invention. The operation of FIG. 23 is performed in response to a login request by the user who receives the email at S149.

In response to the login request from the user, at S2, user terminal 10 sends a login request to the e-book sales agency server 100B. At S3, the e-book sales agency server 100B authenticates the user. Assuming that authentication is successful, the e-book order acceptance unit 105 searches the book collection status management table 700 using the user ID “user1” of the login user as a search key to obtain the path of the e-book selection screen, which is stored in the field 703 for the user ID “user1”.

The e-book order acceptance unit 105 obtains the e-book selection screen through accessing the obtained path at S18A, and transmits the obtained e-book selection screen to the user terminal 10 at S19.

At S20, the user terminal 10 causes the display 308 to display the e-book store selection screen received from the e-book sales agency server 100B.

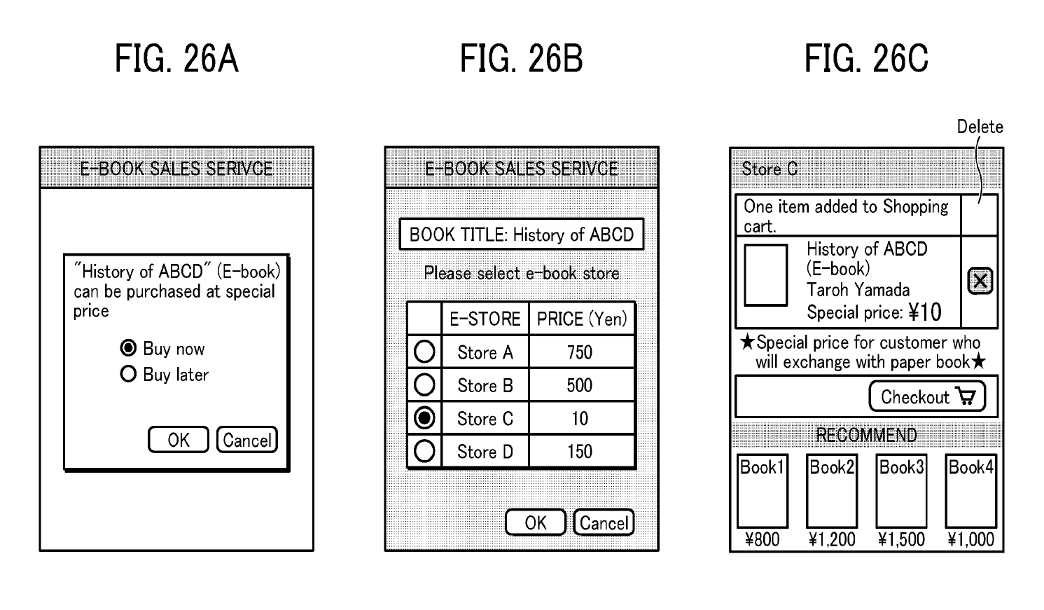

FIGS. 26A and 26B are example e-book store selection screens. The user terminal 10 firstly displays the e-book store selection screen of FIG. 26A, which includes a message indicating that “History of ABCD (E-book) can be purchased at a special price”, and two radio buttons corresponding to the option “Buy now” and the option “Buy later” for selection by the user. When the “OK” key is pressed after selecting the “Buy now” option, the user terminal 10 switches to the e-book store selection screen of FIG. 26B.

When the user selects the e-book store “C” that offers the e-book for the lowest price, and selects the “OK” key, at S21, the user terminal 10 receives the user selection of the e-book store. At S22, the user terminal 10 sends the selected e-book store “C” to the e-book sales agency server 100B.

At S23, the e-book ordering unit 106 searches the user information registration table 600 (FIG. 5) using the user ID of the user at the user terminal 10 and the selected e-book store “C” as a search key, to obtain information that is needed for the e-book ordering unit 106 to order the e-book on behalf of the user. More specifically, the e-book ordering unit 106 searches the user information registration table 600 using the user ID “user1” and the e-book store “C” as a search key to obtain the account information, that is, the user ID “user1@emai.com” and the password “12341234”, of the user for the e-book store “C” and the URL of the e-book store “C” http://www.ccc.co.jp/ . . . .

At S24, the agency authenticator 107 transmits a login request including the obtained account information (user ID “user1@email.com” and password “12341234”), to the URL of the e-book store “C”.

At S25, the e-book seller server 20 of the e-book store “C” (simply referred to as the e-book store “C” server 20) authenticates the user using the account information of the login request. At S26, the e-book store “C” server 20 sends an authentication result to the agency authenticator 107 of the e-book sales agency server 100B. In this example, it is assumed that the authentication is successful. In such case, the e-book store “C” server 20 sends an authentication ticket to the e-book sales agency server 100B.

At S27A, the e-book ordering unit 106 generates order information including the ISBN of the e-book (In this example, the title “History of ABCD”), the book ID of the paper book, and information regarding the special price, and transmits the order information to the e-book store “C” server 20. In this example, the information regarding the special price includes information indicating the selected service (in this example, the exchange), and a certificate for certifying that the login user has a right to purchase the e-book at the special price.

At S28A, the e-book store “C” server 20 checks the certificate and the selected service (the exchange), from the information regarding the special price that is received from the e-book sales agency server 100B.

At S29, the e-book store “C” server 20 accepts and processes the order of purchasing the e-book having the ISBN that is included in the order information received from the e-book sales agency server 100B. More specifically, the e-book store “C” server 20 accepts an order of purchasing the e-book (with the title “History of ABCD”) at the special price of 10 Yen.

S30 to S35 are performed in a substantially similar manner as described above referring to S30 to S35 of FIG. 6B. In this example, however, an example order confirmation screen indicates that the user can purchase the e-book at a special price.

FIG. 26C illustrates an example order confirmation screen for display at the user terminal 10. The order confirmation screen of FIG. 26C displays an image reflecting the e-book store “History of ABCD” (e-book), and a message indicating that a copy of e-book is available for the user who has exchanged with this paper book at a special price of 10 Yen.

In the above-described embodiment referring to FIGS. 22 and 23, the e-book sales agency provides the e-book store with business platform for promoting sales of e-books. More specifically, the e-book sales agency server 100B offers sales of an e-book associated with a paper book in exchange of the paper book at a special price (that is, at a discount price or even at free) to the user. The e-book sales agency server 100B further simplifies a process of exchanging the paper book that the user currently owns with the e-book. This business platform promotes not only the sales of e-books for the e-book store, but also promotes transaction of used book for the used book store.

### Third Embodiment

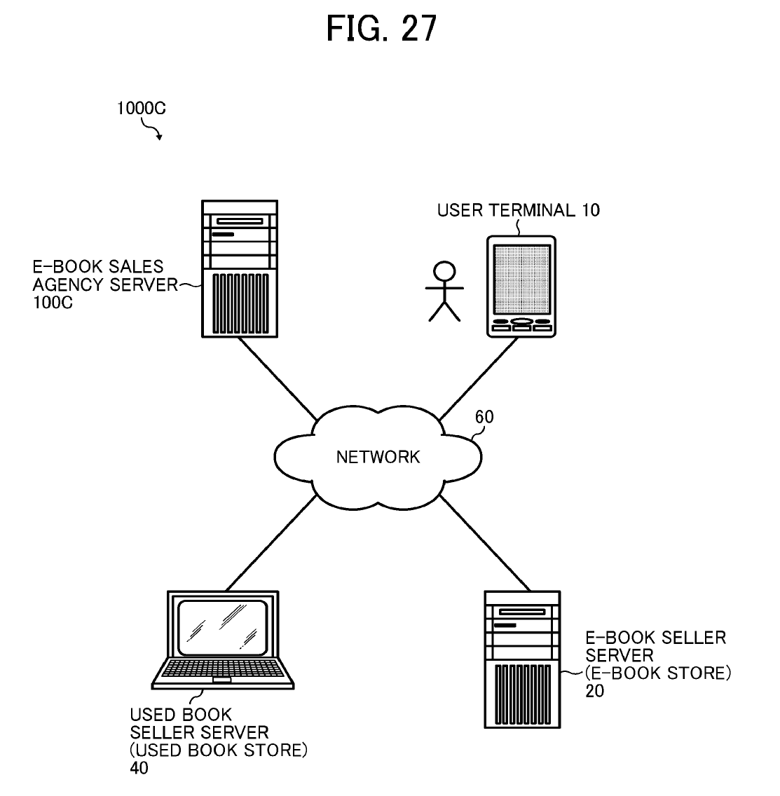

FIG. 27 is a schematic diagram illustrating a configuration of a network system 1000C, which includes an e-book sales agency server (system) 100C, the e-book seller server 20, and the used book seller server 40. These servers are connected through the network 60 such as the Internet or VPN to be communicable with one another. Further, in this example, the used book seller server 40 is implemented by a mobile PC such as a notebook PC or a tablet PC.

More specifically, in the following embodiment illustrated in FIGS. 27 to 40, the e-book sales agency offers business platform that offers a right to have an e-book at a special price (even at free) in exchange of a paper book, to the user who owns the paper book, instead of offering money to the user for the paper book. This business platform is substantially similar to the one described above referring to FIGS. 22 and 23. However, in this embodiment, the used book store, who has collected the used book from the user, pay some fee to the e-book store that will sell the e-book to the user at a special price.

The e-book store thus benefits from such business platform as sales of e-books increase or at least promoted. Although the e-book store sells the e-book at a special price, the e-book store can receive some money from the used book store.

Further, the used book store benefits from such business platform as collection of used books increases. Although the used book store pays some money to the e-book store, the used book store does not have to pay money to the user when buying the used book from the user.

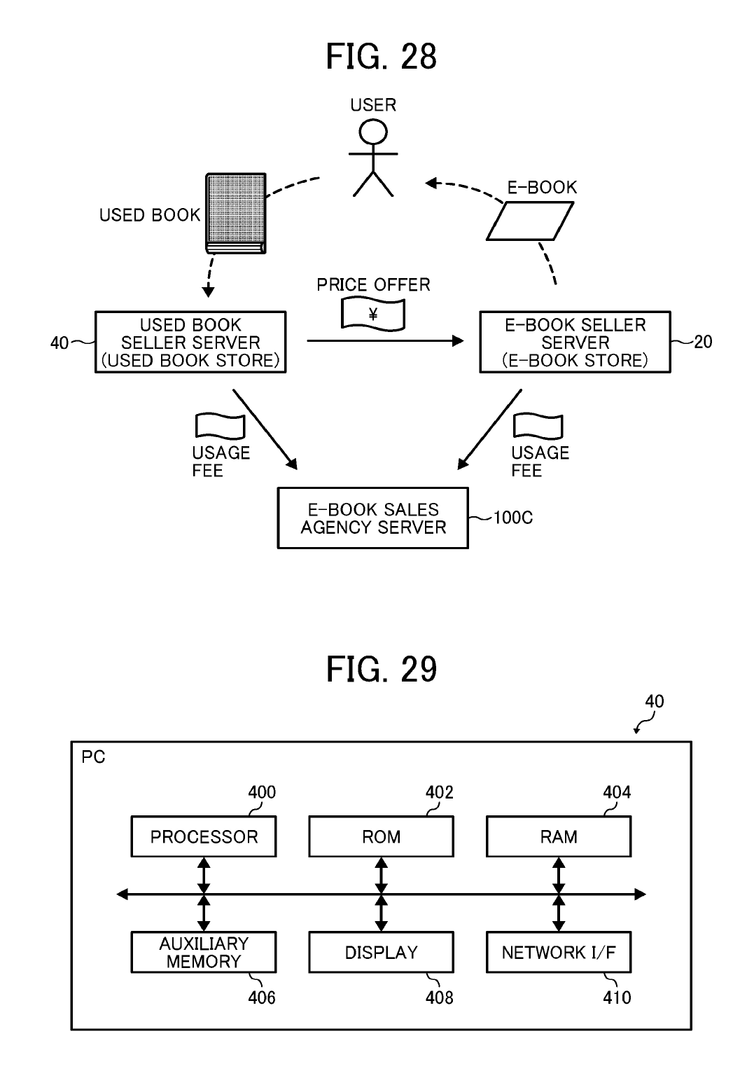

FIG. 28 describes the business platform for promoting sales of e-books as well as collection of used books according to this embodiment.

Instead of offering money for the used book, the used book store offers a right to purchase an e-book associated with the paper book at a special price, to the user who will exchange the paper book with the e-book. The e-book store sells the e-book associated with the paper book to the user who is given the right to purchase the e-book of the paper book, at the special price. The used book store thus pays no money to the user. The used book store pays a fee, which is determined based on a price of the used book, to the e-book store for selling the e-book to the user at the special price.

The e-book sales agency charges a fee for providing such business platform to at least one of the e-book store and the used book store. For example, as illustrated in FIG. 28, the used book store and the e-book store may both pay a usage fee to the e-book sales agency. As described below, the business platform provided by the network system 1000C is operated and maintained by the e-book sales agency in cooperation with the e-book store and the used book store.

Since the hardware configuration of the network system 1000C is the same as that of the network system 1000A of FIG. 2, description thereof is omitted. However, in this embodiment, the used book seller server 40 is implemented by a mobile PC having the hardware configuration of FIG. 29.

As illustrated in FIG. 29, the used book seller server 40 includes a processor 400, a ROM 402, a RAM 404, an auxiliary memory 406, a display 408, and a network I/F 410.

The processor 400 controls an entire operation of the server. The ROM 402 is a non-volatile memory that stores various programs such as a book program like BIOS, and firmware. The RAM 404 is a non-volatile memory that functions as a work memory for the processor 400 in executing the program. The auxiliary memory 406 may be implemented by a HDD of large-size capacity, which stores an operating system and application. The display 408 is a display capable of displaying various information to the user, and receiving various user inputs through a touch panel. The network I/F 410 is an interface that connects the server 40 with the network 60.

Referring to FIG. 30, a functional configuration of the e-book sales agency server 100C is explained according to the embodiment of the present invention.

As illustrated in FIG. 30, the e-book sales agency server 100C includes a book information registrar 1002, a coupon generator 1003, a coupon distributor 1004, an e-book sales page director 1005, an e-book sales manager 1006, a charging unit 1007, and the database 111.

The book information registrar 1002 associates identification information of a paper book and identification information of an e-book. The coupon generator 1003 generates an electronic coupon for purchasing an e-book at a special price. The coupon distributor 1004 transmits information for obtaining the electronic coupon, to the used book seller server 40.

The e-book sales page director 1005 directs the user at the user terminal 10, which has downloaded the electronic coupon, to an e-book sales page where the e-book is sold. The e-book sales manager 1006 obtains and stores sales information regarding the e-book sold with the electronic coupon, from the e-book seller server 20.

The charging unit 107 charges a fee to the used book store or the e-book store.

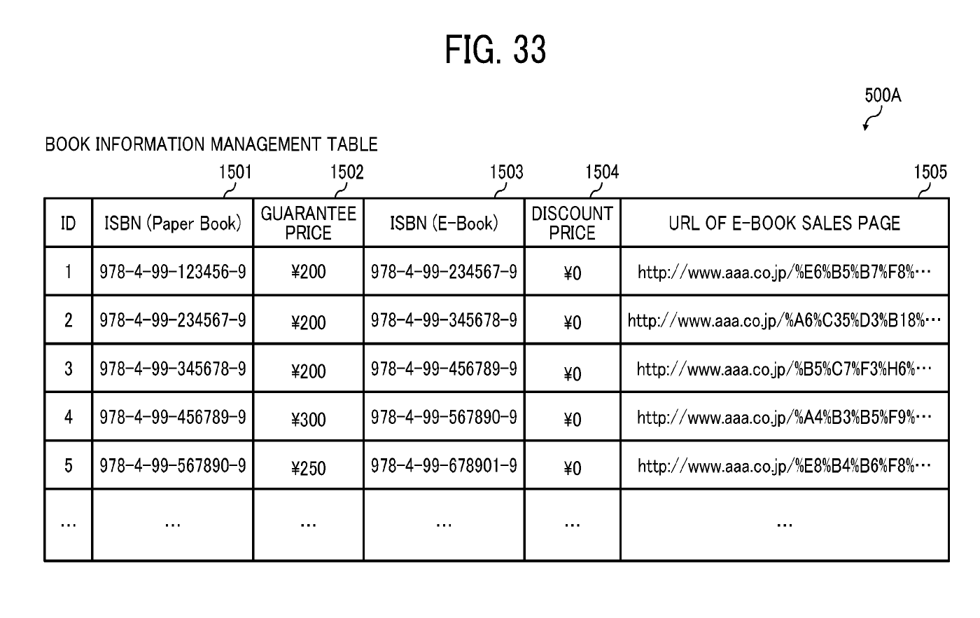

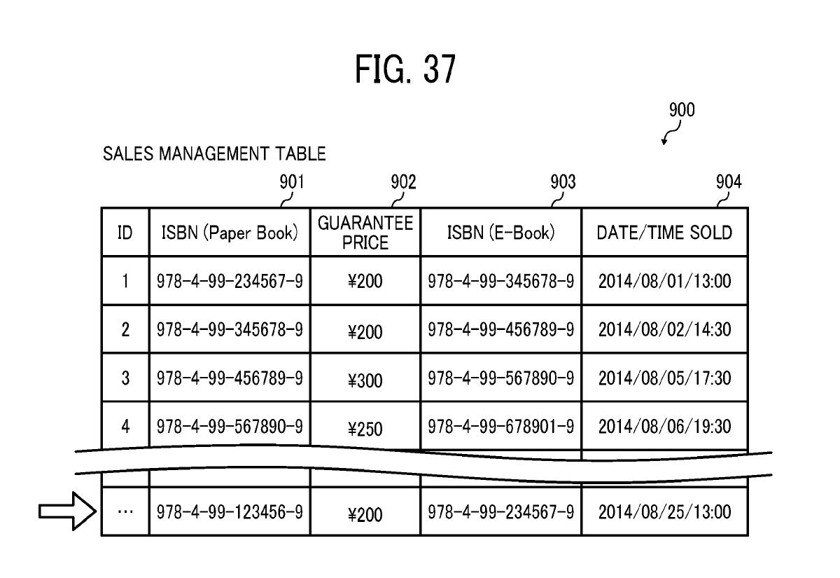

The database 111 stores various information to be used by the e-sales agency server 100C, such as the book information management table 500A of FIG. 33 and a sales management table 900 of FIG. 37.

The above-described units in FIG. 30 are implemented by a plurality of instructions that are generated by the processor 200 in cooperation with any desired memory such as the ROM 202 or the auxiliary memory 206.

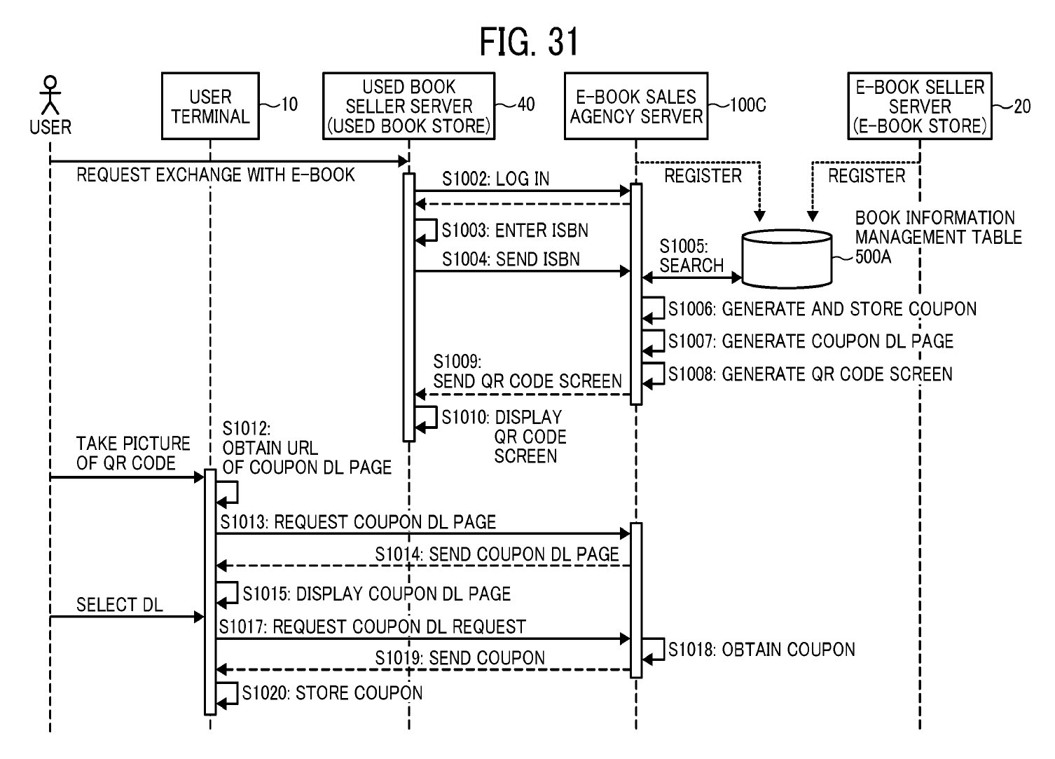

Referring to FIG. 31, operation of processing a request for exchanging a paper book with an e-book, performed by the e-book sales agency server 100C in cooperation with the used book store and the e-book store, is explained according to an embodiment of the present invention. In this example, the user visits the used book store with a paper book that the user currently owns to request for exchange with an e-book. In response to such request, the e-book sales agency server 100C issues an electronic coupon to the user. Further, it is assumed that the user has a smart phone, which functions as the user terminal 10.

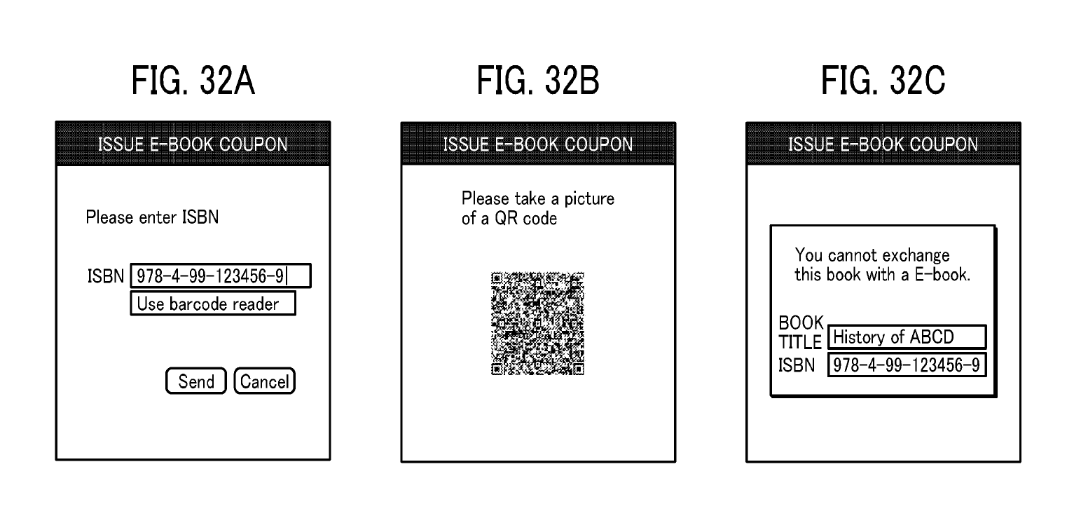

When the user brings the used book (paper book) to exchange with the e-book, at S1002, a staff at the used book store operates the used book seller server 40 to log in the e-sales agency server 100C. When login is successful, the used book seller server 40 causes the display 408 to display an e-book coupon issuance screen, as illustrated in FIG. 32A.

As the staff at the used book store enters identification of the used book that the user has brought on a text box of the e-book coupon issuance screen of FIG. 32A, the used book seller server 40 receives the identification of the used book. In this example, an ISBN is used as identification of the used book.

In alternative to manually entering the ISBN, the user may take a picture of a QR code printed on the used book. More specifically, when the “Use barcode reader” key is selected on the screen of FIG. 32A, the display 408 displays a screen requesting the staff at the used book store to capture an image of the QR code printed on the used book.

After entering the ISBN of the used book, at S1004, the used book seller server 40 transmits the ISBN to the e-book sales agency server 100C.

At S1005, the coupon generator 1003 of the e-book sales agency server 100C searches the book information management table 500A of FIG. 33 using the received ISBN as a search key to obtain information regarding an e-book that can be exchanged with the paper book having the obtained ISBN.

Referring to FIG. 33, the book information management table 500A includes a “ISBN (paper book)” field 1501 for storing the ISBN of a paper book, a “guarantee price” field 1502 for storing a guarantee price, a “ISBN (e-book)” field 1503 for storing the ISBN of an e-book, a “discount price” field 1504 for storing a discount price (or a special price) to be offered to the user in purchasing the e-book, and a “URL of e-book sales pages” field 1505 for storing a URL of an e-book sales page.

In this embodiment, the book information registrar 102 of the e-sales agency server 100C previously registers various information in the book information management table 500A. For example, the book information registrar 102 provides a wizard to each one of the used book seller server 40 and the e-book seller server 20, to guide the used book store and the e-book store to input various information.

According to the wizard, the used book store registers the ISBN of the used book (paper book) that the used book store will purchase, and a guarantee price, respectively, in the field 1501 and the field 1502. The guarantee price in this example corresponds to an amount of payment that the used book store promises to pay the e-book store, when the user purchases the e-book from the e-book store at a discount price (even at free). For example, the staff at the used book store may enter the amount of money that is determined based on a market price of the used book, as a guarantee price in the field 1503.

The e-book store registers the ISBN of an e-book that can be sold in the field 1503, and a discount price (special price) of that e-book in the field 1504. The e-book store determines the e-book, or the discount price of the e-book, while considering the guarantee price to be paid by the used book store. For example, the e-book store may register the price “0” (free) as a discount price to be offered to the user.

Referring back to FIG. 31, at S1006, the coupon generator 1003 generates an electronic coupon, which includes the ISBN of the used book (paper book) that is received from the used book seller server 40, the ISBN of the e-book, the guarantee price, and the discount price that are associated with the ISBN of the paper book in the book information management table 500A, and a certificate indicating a right to purchase the e-book at the discount price. This electronic coupon is to be used by the user who requests to exchange the paper book with an e-book, when purchasing the e-book. Further, at S1006, the coupon generator 1003 stores the electronic coupon in a predetermined memory area.

At S1007, the coupon distributor 1004 generates a coupon download (DL) page, which is embedded with a path of the memory area where the electronic coupon is stored.

At S1008, the coupon distributor 1004 further encodes the URL (path) of the coupon download page generated at S1007 into a QR code, and generates a screen that includes the QR code for display.

At S1009, the coupon distributor 1004 transmits the QR code screen to the used book seller server 40. In alternative to encoding the URL of the coupon download page in the QR code, the URL of the coupon download page may be encoded in any other form such as the other two dimensional code or one dimensional code such as the barcode.

At 1010, the used book seller server 40 causes the display 408 to display the QR code screen received from the e-book sales agency server 100C, such as a QR code screen illustrated in FIG. 32B.

Referring back to S1005, when the coupon generator 1005 could not find any record having the ISBN of the paper book that is received from the used book seller server 40, or could not find any ISBN of the e-book associated with such paper book, the coupon generator 105 generates a message indicating that the used book that the user has brought cannot be exchanged with an e-book, and transmits such message to the used book seller server 40. FIG. 32C illustrates an example screen including such message for display by the display 408 of the used book seller server 40.

As the display 408 of the e-book sales agency server 100C displays the QR code screen of FIG. 32B, the staff at the used book store asks the user to capture an image of the QR code that is displayed using a camera function of the user terminal (smart phone) 10. The user takes a picture of the QR code displayed on the display 408 using the camera of the smart phone 10. At S1012, the user terminal 10 analyzes the captured QR code to obtain the URL of the coupon download page. At S1013, the user terminal 10 requests the e-book sales agency server 100C for the obtained URL of the coupon download page, for example, by accessing the obtained URL of the coupon download page. At S1014, the coupon distributor 1014 of the e-book sales agency server 100C transmits the coupon download page, generated and stored at S1008, to the user terminal 10.

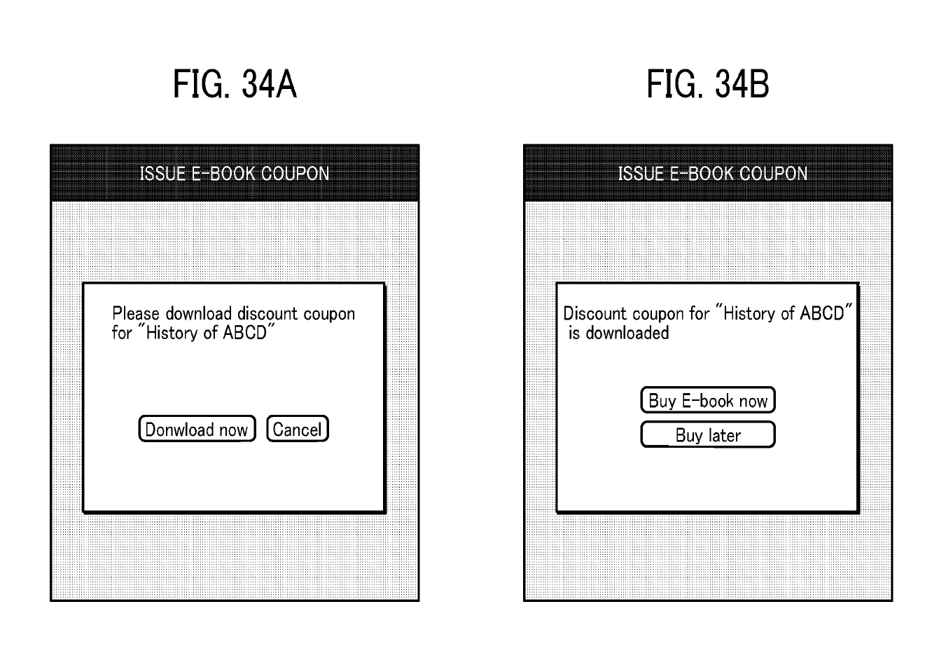

At S1015, the user terminal 10 causes the display 308 to display the coupon download page, which is received from the e-book sales agency server 100C. FIG. 34A illustrates an example coupon download page for display at the user terminal 10.

When the user selects the “Download now” key on the coupon download page of FIG. 34A, at S1017, the user terminal 10 sends a request for downloading the electronic coupon to the e-book sales agency server 100C. The download request includes the path of the electronic coupon embedded in the coupon download page.

The coupon distributor 1004 obtains the electronic coupon, which is stored in the memory area specified by the path of the download request at S1018, and transmits the obtained electronic coupon to the user terminal 10 at S1019.

At S1020, the user terminal 10 stores the electronic coupon in a predetermined memory area of the user terminal 10. For example, the web browser of the user terminal 10 may store the electronic coupon with the web storage of HTML 5.

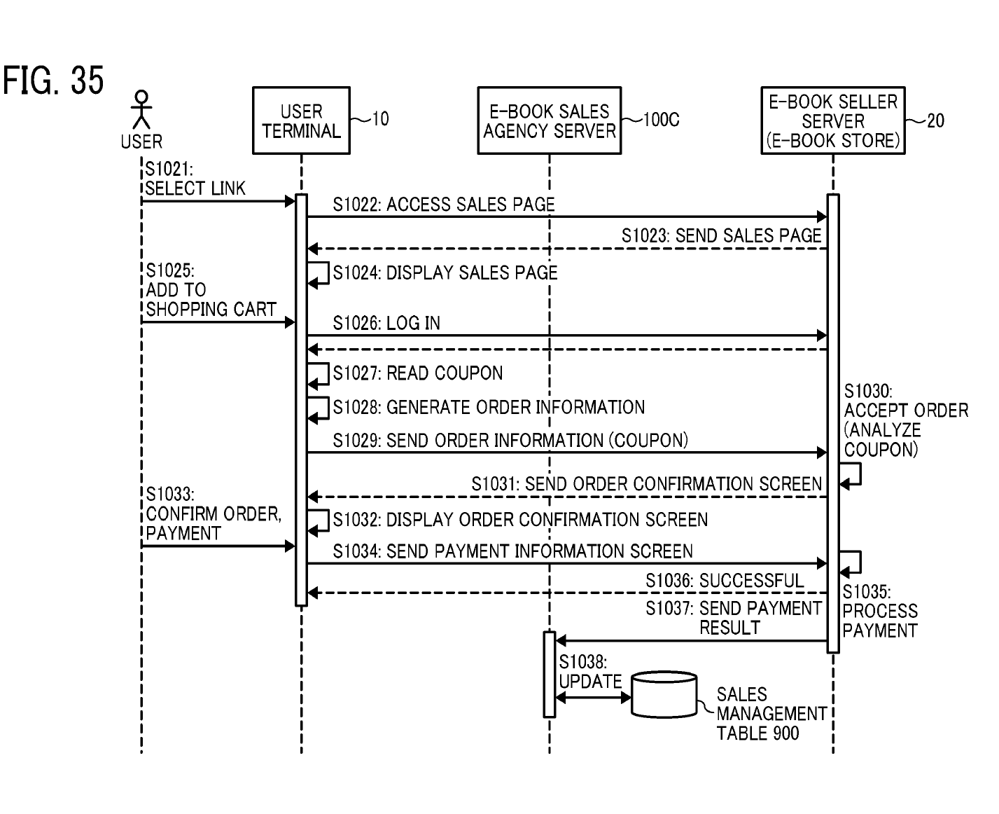

Referring to FIG. 35, operation of processing an order of purchasing an e-book using the electronic coupon, performed by the e-book sales agency server 100C, is explained according to an embodiment of the present invention. More preferably, in this example, when the coupon distributor 1004 transmits the electronic coupon to the user terminal 10 as described above referring to FIG. 31, the e-book sales director 105 transmits a link page having a link to the e-book sales page to the user terminal 10.

More specifically, the e-book sales director 105 searches the book information management table 500A (FIG. 33) using the ISBN of the e-book that is included in the electronic coupon to obtain the URL of the e-book sales page that is associated with the ISBN of the e-book. The e-book sales page director 105 generates the link page having the obtained URL embedded therein, and transmits such link page to the user terminal 10.

FIG. 34B illustrates an example link page for display at the user terminal 10. The link page of FIG. 34B includes information regarding an e-book (title: “History of ABCD”) that the user can purchase at the discount price using the coupon.

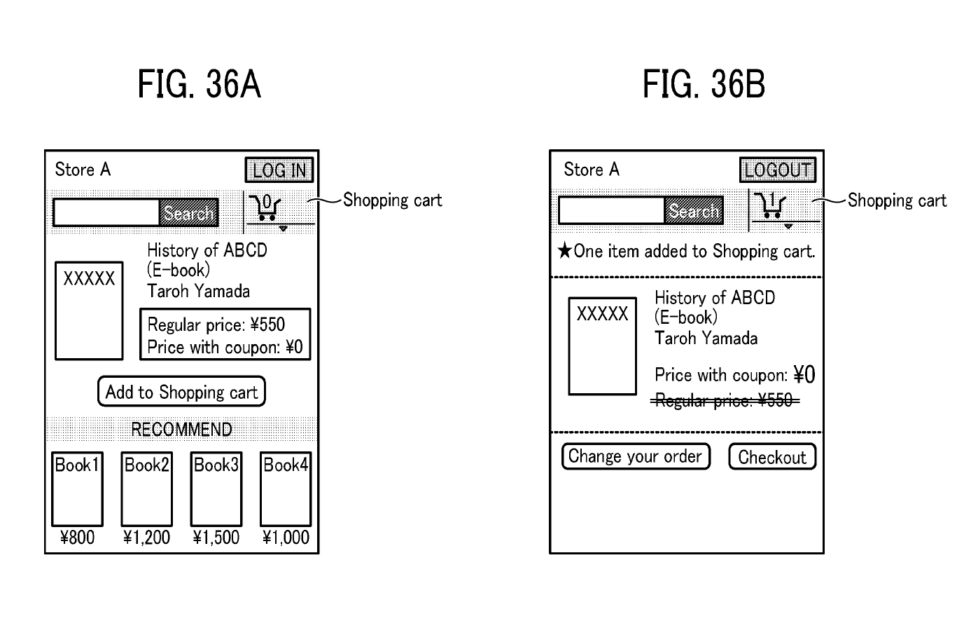

Referring to FIG. 35, when the user at the user terminal 10 selects the “Buy E-book now” key, at S1021, the user terminal 10 receives such selection. At S1022, the user terminal 10 accesses the sales page of the e-book “History of ABCD”, using the URL of the link page of FIG. 34B. At S1023, the e-book sales agency server 100C transmits the sales page of the e-book “History of ABCD” to the user terminal 10. At S1024, the user terminal 10 causes the display 308 to display the sales page of the e-book “History of ABCD”. FIG. 36A illustrates an example sales page of the e-book “History of ABCD”.

When the user selects the “Add to shopping cart” key on the screen of FIG. 35A, at S1025, the user terminal 10 receives such instruction. At S1026, the user terminal 10 switches to a login screen that requests the user to login the e-book seller server 20.

At S1026, the user terminal 10 logs in the e-book seller server 20. When authentication is successful, at S1027, the user terminal 10 reads out the electronic coupon that is stored at S1020 (FIG. 31). At S1028, the user terminal 10 generates order information including the read electronic coupon. At S1029, the user terminal 10 transmits the order information to the e-book seller server 20.

At S1030, the e-book seller server 20 analyzes the electronic coupon obtained from the order information to process the order of purchasing the e-book according to the contents of the electronic coupon. More specifically, the e-book seller server 20 adds the e-book “History of ABCD” to the shopping cart at the special price of 0 Yen.

At S1031, the e-book seller server 20 transmits an order confirmation screen to the user terminal 10. At S1032, the user terminal 10 causes the display 308 to display the order confirmation screen, such as an order confirmation screen of FIG. 36B.

The order confirmation screen of FIG. 36B indicates that the e-book “History of ABCD” is added to the shopping cart at a discount price of 0 Yen.

As the user at the user terminal 10 selects the “Checkout” key on the screen of FIG. 36B, the user terminal 10 further displays a payment screen provided by the e-book seller server 20. After inputting information such as credit card information to process payment, at S1033, the user terminal 10 receives payment information from the user. At S1034, the user terminal 10 sends the payment information to the e-book seller server 20.

At S1035, the e-book seller server 20 processes payment using the payment information received from the user terminal 10. Assuming that the payment process is successful, at S1036, the e-book seller server 20 transmits the payment result indicating that it is successful to the user terminal 10. The user can then access a specific site provided by the e-book seller server 20 to download the e-book “History of ABCD” at any desired time.

After the e-book seller server 20 ends a session with the user terminal 10, at S1037, the e-book seller server 20 transmits a payment result indicating that the e-book has been sold, to the e-book sales agency server 100C. More specifically, the e-book seller server 20 transmits the payment result including the electronic coupon that has been used by the user in purchasing, to the e-book sales agency server 100C.

At S1038, the e-book sales manager 1006 of the e-book sales agency server 100C updates the sales management table 900 of FIG. 37.

The sale management table 900 includes a “ISBN (paper book)” field 901 for storing the ISBN of a paper book, a “guarantee price” field 902 for storing a guarantee price, a “ISBN (e-book)” field 903 for storing the ISBN of an e-book associated with the paper book, a “date/time sold” field 904 for storing the date and time when the e-book is sold.

More specifically, at S1038, the e-book sales manager 1006 extracts the ISBN of the paper book, the guarantee fee, and the ISBN of the e-book, from the electronic coupon included in the payment result that is received from the e-book seller server 20, and stores such information respectively in the fields 901, 902, and 903. The e-book sales manager 1006 further stores the date and time when the payment result is received in the field 904.

Now, operation of charging a fee, performed by the charging unit 1007 of the e-book sales agency server 100C, is described in this embodiment.

The charging unit 1007 reports information on the sales management table 900, respectively, to the used book store and the e-book store, at a preset time such as at every accounting deadline. Based on the reported information, the e-book store may ask the used book store to pay a total guarantee price, such that the total guarantee price will be paid to the e-book store. The total guarantee price may be calculated by any party, such as by the used book store, the e-book store, or the e-book sales agency based on information stored in the sales management table 900. In one example, the charging unit 1007 may obtain the total guarantee price, and sends such information to at least one of the used book seller server 40 and the e-book seller server 20.

Further, the charging unit 1007 may charge a usage fee of the e-book sales agency service to each one of the used book store and the e-book store. More specifically, in one example, the charging unit 1007 calculates total e-book sales based on information on the sales management table 900, and further calculates a usage fee based on the total e-book sales to be charged to the used book store. The charging unit 1007 further calculate a usage fee for the e-book store based on the total guarantee fee, and charges such usage fee to the e-book store. Alternatively, the charging unit 1007 calculates a usage fee based on the total e-book sales and the total guarantee fee, and charges a preset percentage of the usage fee to the used book store while charging the rest of the preset percentage of the usage fee to the e-book store.

In the above-described embodiment, it is assumed that one used book store and one e-book store are present on the network system 1000C for simplicity. In reality, however, a large number of used book stores and e-book stores participate in this business platform. In the following, operation of processing an order of purchasing an e-book in exchange of a paper book is explained when more than one used book store and more than one e-book store are provided.

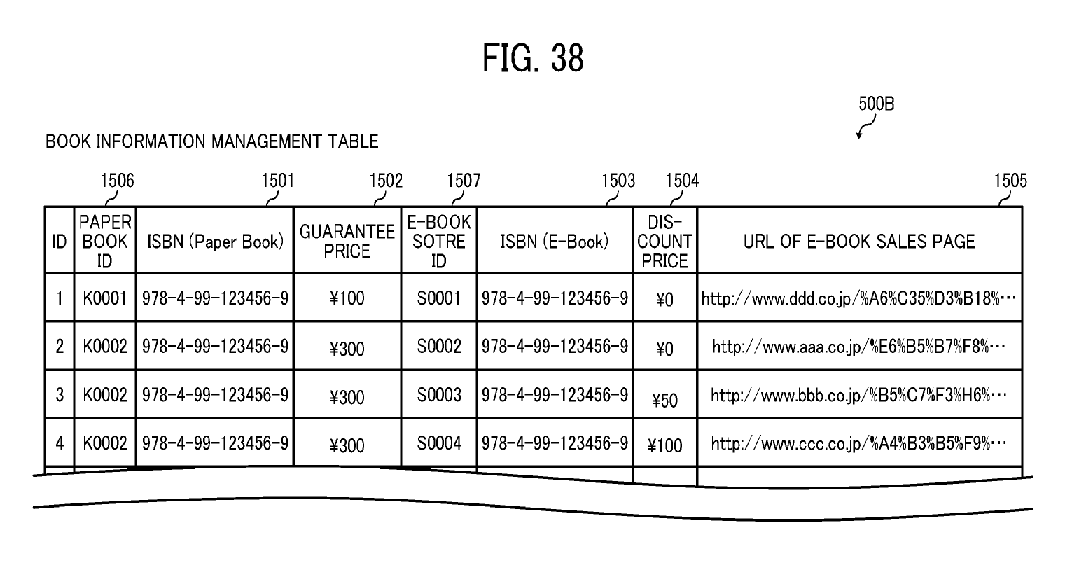

FIG. 38 is an example data structure of a book information management table 500B, which is to be managed by the e-book sales agency server 100C.

The book information management table 500B of FIG. 38 additionally includes a “paper book ID” field 1506 for storing a book ID of the used book (paper book), and an “e-book store” field 507 for storing identification of the e-book store.

In this embodiment, the book information registrar 1002 accepts, for the e-book having the same ISBN, a plurality of guarantee prices that are offered respectively by a plurality of used book stores. Similarly, the book information registrar 1002 accepts, for the e-book having the same ISBN, a plurality of discount prices that are offered respectively by a plurality of e-book stores.

When the staff at the used book store enters the ISBN of the paper book to be exchanged through the coupon issuance screen of FIG. 32A, at S1004 of FIG. 31 (FIG. 31), the used book seller server 20 transmits the obtained ISBN of the used book to the e-book sales agency server 100C. At S1005, the coupon generator 1003 of the e-book sales agency server 100C searches the book information management table 500B of FIG. 38 using the ISBN received from the used book seller server 40. When a plurality of e-book stores (that is, a plurality of e-book store IDs) are stored for the ISBN of the used book, the coupon generator 1003 generates an e-book store screen for display at the used book seller server 40, which lists a plurality of e-book stores. More specifically, a plurality of records having the obtained ISBN of the paper book in the field 1501 is extracted. Based on the extracted records, the coupon generator 1003 generates the e-book store screen that lists a plurality of e-book stores corresponding to the e-book store IDs (field 1507), and the discount prices (field 1504) offered by the e-book stores.

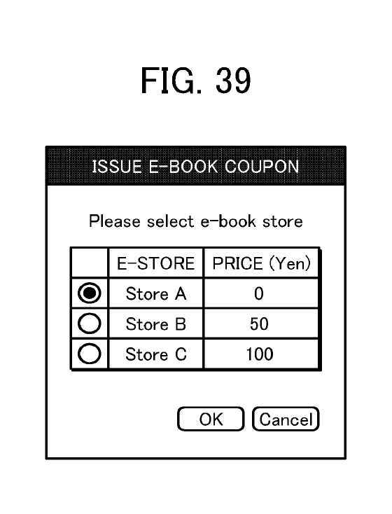

FIG. 39 illustrates an example e-book store screen, which requests the user at the user terminal 10 to select one of the e-book stores listed on the screen. The used book seller server 40 sends information regarding the user selection of the e-book store to the e-book sales agency server 100C. The coupon generator 1003 further searches the book information management table 500B using the ISBN of the used book and the e-book store ID of the selected e-book, as a search key, to obtain information regarding the e-book to be purchased. More specifically, the coupon generator 1003 generates an electronic coupon including the ISBN of the used book (paper book) received from the used book seller server 40, the ISBN of an e-book, a guarantee price, and a discount price that are associated with the used book ISBN for the selected e-book store, a certificate indicating a right to purchase the e-book at the discount price, a user book store ID of the used book store that transmits the used book ISBN, and an e-book store ID of the selected e-book store.

As described above, in this embodiment, the e-book store tends to choose the used book store as a partner, which can offer higher guarantee prices. Accordingly, those used book stores capable of offering higher guarantee prices are more likely to issue a larger number of electronic coupons, such that such used book stores would be able to collect more used books from the users.

The user tends to choose the e-book store that the user buys the e-book from, which can offer lower discount prices. Accordingly, those e-book stores capable of offering lower discount prices are more likely to sell a larger number of e-books, such that such e-book stores would be able to collect more customers. This further lowers the discount prices to close to “0”, thus giving incentive to the user in exchanging the paper book with the e-book. This further promotes transaction of paper books (used books) as well as sales of e-books.

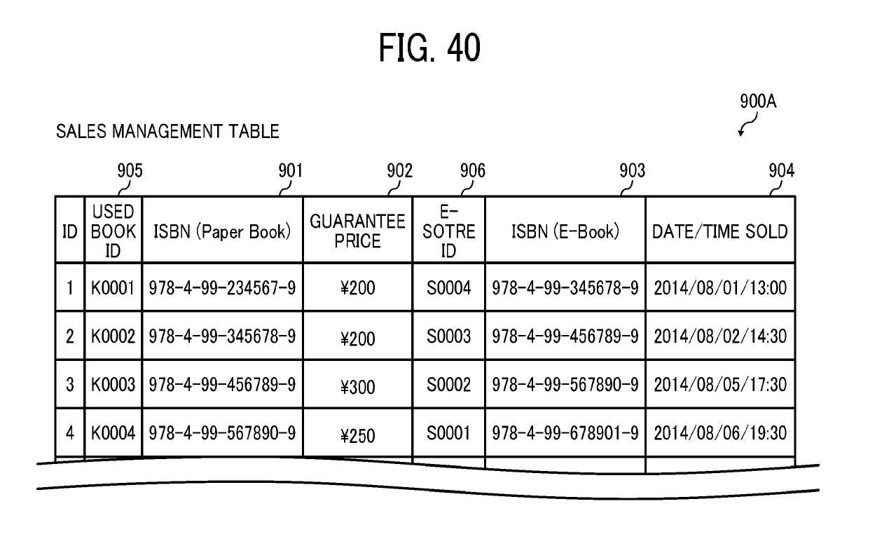

Referring now to FIG. 40, calculating a usage fee of the e-book sales agency service to be charged to each one of a plurality of e-book stores and used book stores is explained.

As illustrated in FIG. 40, the sales management table 900A additionally includes a field 905 for storing the used book store ID, and a field 906 for storing the e-book store ID.

The e-book sales manager 1006 extracts the used book ID, the ISBN of the paper book, the guarantee fee, the e-book store ID, and the ISBN of the e-book, from the payment result, and stores such information respectively in the fields 905, 901, 902, 906, and 903. The e-book sales manager 1006 further stores the date and time at which the payment result is received in the field 904.

The charging unit 1007 calculates the results (such as the total sales) using information on the sales management table 900A, and charges a usage fee based on the calculated result to each one of the used book stores and each one of the e-book stores.

As described above, in this embodiment, the e-book sales agency provides both the used book store and the e-book store with business platform for promoting sales of e-books as well as transaction of paper books. More specifically, the e-book sales agency server 100C offers an e-book at a special price to the user who will exchange a paper book with an e-book.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

The illustrated server apparatuses are only illustrative of one of several computing environments for implementing the embodiments disclosed herein. For example, in some embodiments, the e-book sales agency server 100 (100A, 100B, and 100C) includes a plurality of computing devices, e.g., a server cluster, that are configured to communicate with each other over any type of communications link, including a network, a shared memory, etc. to collectively perform the processes disclosed herein. Similarly, any one of the e-book seller server 20, the new book seller server 30, the used book seller server 40, and the used book collection center server 50 can include a plurality of computing devices that are configured to communicate with each other.

Moreover, the e-book sales agency server 100 and the e-book seller server 20 can be configured to share the processing steps disclosed, e.g., in FIG. 6, in various combinations. For example, the processes of obtaining the ISBN of the e-book associated with the paper book owned by the user, performed by the e-book seller server 20 at S16, may be performed by the e-book sales agency server 100, if association information indicating an association between the paper book ISBN and the e-book ISBN is available.

Further, the illustrated elements of the e-book sales agency server 100 and the e-book seller server 20 can be combined into a single server apparatus. In such case, the server apparatus performs a sequence of operations from operation of receiving the ISBN of the paper book, to operation of purchasing the e-book associated with the paper book at a special price.

Further, processing of payment may be performed by any server other than the e-book seller server 20, for example, by the server at the third party who is authorized to process payment by the e-book store. In such case, information regarding the payment may be transmitted from such third party to the e-book sales agency server 100.

Further, each of the plurality of computing devices is configured to communicate with one or more external computing devices using any type of communication link, including any combination of wired and wireless communication links; using any type of network, including the Internet, a wide-area network (WAN), a local-area network (LAN), and a virtual private network (VPN); and using any combination of transmission techniques and communication protocols.

Further, any one of the above-described functions or operations may be implemented as a computer program, which may be written in any language such as C, C++, C#, or Java. Such computer program may be recorded on any desired memory such as a hard disk drive, CD-ROM, MO, DVD, flexible disk, EEPROM, and EPROM.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

1. An e-book sales agency server apparatus at an e-book sales agency, coupled to an e-book store server apparatus at an e-book store on a network, the server apparatus comprising:
a memory that stores, for each one of a plurality of users, first authentication information of the user for authentication by the e-book sales agency, and second authentication information of the user for authentication by the e-book store;
a receiver that receives, from a user terminal operated by a first user of the plurality of users, first authentication information of the first user for authentication by the e-book sales agency;
processing circuitry that obtains e-book identification information for identifying an e-book, and obtains second authentication information of the first user for authentication by the e-book store using information stored in the memory;
a transmitter that transmits an order of purchasing the e-book having the obtained e-book identification information to the e-book store server apparatus at the e-book store on behalf of the first user using the second authentication information of the first user, and
wherein, in response to receiving information indicating that the electronic book having the obtained e-book identification information is purchased by the first user from the e-book store, the processing circuitry updates charge fee information to be used for calculating an amount of fee that is charged to the e-book store by the e-book sales agency.

2. The server apparatus of claim 1, wherein
the receiver further receives address information indicating an address of an order confirmation screen including information regarding the order of purchasing the e-book, from the e-book store server apparatus, and
the transmitter transmits an instruction for redirecting to the order confirmation screen to the user terminal operated by the first user, with the address information.

3. The server apparatus of claim 2, wherein
the transmitter transmits the second authentication information of the first user to the e-book store server apparatus to request for authentication of the first user on behalf of the first user, and
when authentication result information indicating that authentication of the first user is successful is received, the transmitter further transmits the authentication result information to the user terminal to enable the user terminal to redirect to the order confirmation screen provided by the e-book store.

4. The server apparatus of claim 1, wherein the e-book store includes a plurality of e-book stores,
the transmitter transmits an e-book store selection screen that lists the plurality of e-book stores to the user terminal for selection by the first user, and
in response to receiving a selection of one of the plurality of e-book stores through the e-book store selection screen from the user terminal, the processing circuitry obtains the second authentication information of the first user for the selected e-book store.

5. The server apparatus of claim 4, wherein
the transmitter further transmits to the e-book store server apparatus at each one of the plurality of e-book stores, a request that inquiries availability and a price of the e-book having the obtained e-book identification information, and
the processing circuitry generates the e-book store selection screen including information indicating the availability and the price of the e-book for each one of the plurality of e-book stores, based on a response to the request that is received from the e-book store server apparatus at each one of the plurality of e-book stores.

6. The server apparatus of claim 1, wherein
the receiver receives paper book identification information of a paper book owned by the first user from the user terminal operated by the first user, and
the transmitter transmits the paper book identification information of the paper book owned by the first user to the e-book store server apparatus, to request for the e-book identification information of the e-book associated with the paper book owned by the first user.

7. The server apparatus of claim 6, wherein the paper book identification information of the paper book owned by the first user is obtained through decoding an image of a code printed on the paper book that is captured with a camera provided with the user terminal.

8. A system for managing transactions of e-books, the system comprising:
a first server at an e-book sales agency, the first server including a memory that stores, for each one of a plurality of users, first authentication information of the user for authentication by the e-book sales agency, and second authentication information of the user for authentication by the e-book store; and
a second server at an e-book store on a network,
wherein the first server and the second server operate in cooperation with each other and configured to
receive, from a user terminal operated by a first user of the plurality of users, first authentication information of the first user for authentication by the e-book sales agency,
obtain e-book identification information for identifying an e-book,
obtain second authentication information of the first user for authentication by the e-book store using information stored in the memory of the first server,
generate an order of purchasing the e-book having the obtained e-book identification information at the e-book store on behalf of the first user using the second authentication information of the first user, and
in response to receiving information indicating that the electronic book having the obtained e-book identification information is purchased by the first user from the e-book store, update charge fee information to be used for calculating an amount of fee that is charged to the e-book store by the e-book sales agency.

9. The system of claim 8, wherein the first server and the second server are further configured to
generate an order confirmation screen including information regarding the order of purchasing the e-book, and
transmit an instruction for redirecting to the order confirmation screen to the user terminal operated by the first user, with address information indicating an address of the order confirmation screen.

10. The system of claim 8, wherein the first server and the second server are further configured to
transmit an e-book store selection screen that lists a plurality of e-book stores to the user terminal for selection by the first user, and
in response to receiving a selection of one of the plurality of e-book stores through the e-book store selection screen from the user terminal, obtain the second authentication information of the first user for the selected e-book store.

11. The system of claim 10, wherein
the e-book store selection screen includes information indicating availability and a price of the e-book having the obtained e-book identification information, for each one of the plurality of e-book stores.

12. The system of claim 11, wherein
the second authentication information of the user for authentication by the e-book store is stored for each one of the plurality of e-book stores that the user has previously registered.

13. A method of managing transactions of e-books, comprising:
storing in a memory, for each one of a plurality of users, first authentication information of the user for authentication by the e-book sales agency, and second authentication information of the user for authentication by the e-book store;
receiving, from a user terminal operated by a first user of the plurality of users, first authentication information of the first user for authentication by the e-book sales agency;
obtaining e-book identification information for identifying an e-book;
obtaining second authentication information of the first user for authentication by the e-book store using information stored in the memory;
transmitting an order of purchasing the e-book having the obtained e-book identification information to a server at the e-book store on behalf of the first user using the second authentication information of the first user; and
in response to receiving information indicating that the electronic book having the obtained e-book identification information is purchased by the first user from the e-book store, updating charge fee information to be used for calculating an amount of fee that is charged to the e-book store by the e-book sales agency.

14. The method of claim 13, further comprising:
receiving address information indicating an address of an order confirmation screen including information regarding the order of purchasing the e-book, from the server at the e-book store, and
transmitting an instruction for redirecting to the order confirmation screen to the user terminal operated by the first user, with the address information.

15. The method of claim 13, further comprising:
transmitting an e-book store selection screen that lists a plurality of e-book stores to the user terminal for selection by the first user, and
in response to receiving a selection of one of the plurality of e-book stores through the e-book store selection screen from the user terminal, obtaining the second authentication information of the first user for the selected e-book store.
